(19) United States
(12) Patent Application Publication
(10) Pub. No.: US 2026/0266756 A1
(43) Pub. Date: Sep. 10, 2026

(54) Modular Electrochemical Sensing System and Method for Parameter Monitoring

(71) Applicant: Page Technologies Inc., Boulder, CO (US)

(72) Inventors: Elliot Strand, Boulder, CO (US); Payton Goodrich, Boulder, CO (US); Cameron Handeland, Boulder, CO (US)

(73) Assignee: Page Technologies Inc., Boulder, CO (US)

(21) Appl. No.: 19/561,122

(22) Filed: Mar. 9, 2026

Related U.S. Application Data
(60) Provisional application No. 63/768,449, filed on Mar. 7, 2025.

(51) Int. Cl. G01N 27/40; G01N 27/28; G01N 27/333; G01N 27/414; G01N 27/416

(52) U.S. Cl. CPC G01N 27/40; G01N 27/286; G01N 27/3335; G01N 27/414; G01N 27/4167

(57) ABSTRACT

A modular electrochemical sensing system and method that has one or more interchangeable sensor modules each having a substrate carrying electrochemical electrodes including a plurality of working electrodes and at least one reference electrode. The working electrodes comprises chemically selective membrane material that generates respective electrical responses to respective target analytes when exposed to a fluid or porous-media sample. An electronic reader has a module interface configured to removably connect with the interchangeable sensor modules. The electronic reader has measurement circuitry configured to acquire signals from the working electrodes with respect to the reference electrode. The electronic reader has a communication interface configured to transmit data representing the acquired signals. A data processing subsystem is operatively coupled to the electronic reader. The data processing subsystem has one or more processors and memory storing calibration instructions that, when executed, transform the data representing the acquired signals into corrected outputs.

### CROSS-REFERENCE TO RELATED APPLICATION

This application claims priority to U.S. Provisional Application No. 63/768,499, titled Adaptive, Multi-Sensor Platform for Monitoring Physicochemical Parameters, filed Mar. 7, 2025, which is hereby incorporated by reference in its entirety.

### FIELD OF INVENTION

The present disclosure relates to electrochemical sensing systems for monitoring chemical and physical parameters in aqueous and porous-media environments, and more particularly to a modular sensor platform comprising interchangeable sensor modules with ion-selective electrodes and calibration for real-time monitoring of chemical and physical parameters, such as in agricultural, hydroponic, and water quality applications.

### BACKGROUND

The present disclosure relates to the field of electrochemical sensing systems, particularly to modular sensor platforms for monitoring chemical analytes and physical parameters in aqueous, soil, and hydroponic environments. Electrochemical sensing technologies have become tools for environmental monitoring, agricultural management, and water quality assessment, enabling the detection and quantification of ionic species, nutrients, and other chemical constituents in various media.

Electrochemical sensors typically employ working electrodes functionalized with chemically selective materials, such as ion-selective membranes containing ionophores, to generate electrical signals in response to target analytes. These sensors operate in conjunction with reference electrodes that provide stable potential baselines for accurate measurements. The signals generated by such sensors can be processed to determine analyte concentrations, enabling real-time or near-real-time monitoring of environmental conditions.

Current approaches to environmental and agricultural sensing present various challenges. Laboratory-based spectroscopic analysis, while providing accurate results, often involves delays of one to two weeks between sample collection and result delivery, which can limit the ability of growers and environmental managers to make timely decisions. Current sensing technologies involve substantial costs and maintenance requirements that limit their accessibility to many potential users. Traditional electrochemical probes may require frequent recalibration, which can be labor-intensive and may reduce the practicality of long-term deployments. Additionally, electrochemical sensors deployed in complex environmental matrices may experience interference from non-target ionic species, which can affect measurement accuracy. Sensor drift over time represents another consideration in long-term monitoring applications, as gradual changes in electrode response characteristics may impact the reliability of measurements without appropriate compensation mechanisms.

Therefore, a need exists for sensing platforms that address considerations related to cost, maintenance, accuracy, and deployment flexibility for environmental and agricultural monitoring applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a modular electrochemical sensing system may be provided. The system may comprise one or more interchangeable sensor modules each comprising a substrate carrying a plurality of electrochemical electrodes comprising a plurality of working electrodes and at least one reference electrode. One or more of the plurality of working electrodes may comprise chemically selective membrane material that generates respective electrical responses to respective target analytes when exposed to a fluid or porous-media sample. The system may further comprise an electronic reader comprising a module interface configured to removably connect with the one or more interchangeable sensor modules. The electronic reader may comprise measurement circuitry configured to acquire signals from the plurality of working electrodes with respect to the at least one reference electrode. The electronic reader may comprise a communication interface configured to transmit data representing the acquired signals. The system may further comprise a data processing subsystem operatively coupled to the electronic reader. The data processing subsystem may comprise one or more processors and memory storing calibration instructions that, when executed by the one or more processors, transform the data representing the acquired signals into corrected outputs.

In certain examples of the present disclosure, the at least one reference electrode may comprise a silver/silver-chloride reference couple in ionic communication with an electrolyte reservoir and covered by at least one ion-permeable polymeric membrane configured to regulate ion flux to maintain reference-potential stability and reduce drift. In some examples, the at least one ion-permeable polymeric membrane and the electrolyte reservoir may define multiple diffusion pathways via slits or multiple wells. In certain examples, for at least one of the target analytes, the plurality of working electrodes may include a redundant group of two or more substantially similar electrodes configured to generate respective electrical responses to the at least one of the target analytes. In some examples, the electronic reader and the data processing subsystem may be configured to continue providing the corrected outputs when fewer than all electrodes of the redundant group remain within predetermined performance thresholds by excluding or down-weighting signals from electrodes that exceed the thresholds. In certain examples, the data processing subsystem may implement a trained machine-learning model configured to compensate for measurement drift and cross-parameter interference to generate the corrected outputs in real-time. In some examples, the trained machine-learning model may perform ensemble averaging with outlier rejection across signals from electrodes that report a same analyte and may assign quality scores to individual electrode signals for selective weighting. In certain examples, each interchangeable sensor module may further comprise additional working electrodes configured to generate electrical responses indicative of pH and electrical conductivity. In some examples, the module interface of the electronic reader may comprise spring-loaded contacts, conductive pads, or a flexible connector configured to permit tool-free insertion and removal of the one or more interchangeable sensor modules. In certain examples, the chemically selective membrane material may comprise one or more ion-selective membranes including ionophores configured to selectively respond to nitrate and potassium. In some examples, the electronic reader may comprise a wireless communication module configured to wirelessly transmit the data to the data processing subsystem. In certain examples, at least one of the plurality of working electrodes may comprise an electrochemical transistor configured for potentiometric, voltammetric, or amperometric interrogation. In some examples, the plurality of electrochemical electrodes may be conditioned prior to deployment in single-ion and mixed-ion calibration solutions for a predetermined period to equilibrate membranes and reduce initial drift, and the data processing subsystem may store calibration parameters derived from the conditioning.

According to another aspect of the present disclosure, a replaceable sensor module may be provided. The replaceable sensor module may comprise a substrate carrying conductive structures that define electrical interconnects and a reader interface region configured to releasably mate with a reader device. A plurality of electrochemical electrodes may be disposed on the substrate and electrically coupled to the electrical interconnects. The plurality of electrochemical electrodes may comprise a plurality of working electrodes comprising a first redundant group of two or more substantially similar ion-selective electrodes, each including chemically selective membrane material configured to generate an electrical response to a first target analyte when exposed to a fluid or porous-media sample. The plurality of electrochemical electrodes may further comprise at least one reference electrode comprising a reference couple in ionic communication with an electrolyte reservoir and covered by at least one ion-permeable polymeric membrane configured to regulate ion exchange to maintain reference-potential stability and reduce drift during exposure to a sample of a fluid or porous-media. The replaceable sensor module may further comprise a protective encapsulation layer overlying at least a portion of the conductive structures and defining openings that expose active surfaces of the plurality of electrochemical electrodes while inhibiting fluid ingress to the conductive structures.

In certain examples of the present disclosure, the replaceable sensor module may further comprise at least one additional working electrode selected from an ion-selective electrode for a second target analyte different from the first target analyte of the first redundant group, a pH-sensitive electrode, and an electrical-conductivity sensing structure formed by a pair of spaced electrodes. In some examples, the at least one reference electrode may comprise a silver/silver-chloride reference couple in ionic communication with the electrolyte reservoir. In certain examples, the replaceable sensor module may further comprise at least one counter electrode disposed on the substrate and electrically coupled to the electrical interconnects. In some examples, each ion-selective electrode of the first redundant group may comprise an ion-selective membrane including a polymeric matrix, a plasticizer, an ion exchanger, and one or more ionophores selected to interact selectively with the same target analyte. In certain examples, the at least one ionophore may comprise valinomycin when the first target analyte is potassium or a porphyrin-based carrier when the first target analyte is nitrate. In some examples, multiple ionophores may be within the ion-selective membrane to enable simultaneous detection of multiple analytes of the sample. In certain examples, the replaceable sensor module may further comprise one or more of a temperature sensor, an electrical conductivity sensor, and a physical property sensor. In certain examples, the plurality of electrochemical electrodes may further comprise a second redundant group of two or more substantially similar ion-selective electrodes, each including chemically selective membrane material configured to generate an electrical response to a second target analyte different from the first target analyte. In some examples, at least one working electrode may further comprise an ion-to-electron transduction layer disposed between an underlying conductor and the chemically selective membrane material, the ion-to-electron transduction layer comprising a high-surface-area carbon material or a conductive polymer. In certain examples, the substrate may comprise FR-4, polyethylene naphthalate (PEN), polyethylene terephthalate (PET), paper, or a cellulose-based film. In some examples, the reader interface region may comprise a plurality of conductive pads arranged to engage corresponding contacts of the reader device; and/or the system may further comprise one or more of a temperature sensor, an electrical conductivity sensor, another reference electrode, and a physical property sensor.

According to another aspect of the present disclosure, a method for monitoring chemical analytes and physical parameters in fluid or porous-media may be provided. The method may comprise contacting an interchangeable sensor module with a sample of the fluid or porous-media, the interchangeable sensor module comprising a plurality of electrochemical electrodes, the plurality of electrochemical electrodes comprising at least one reference electrode and a plurality of working electrodes functionalized with chemically selective membrane material configured to generate respective electrical responses to one or more target analytes of the sample. The method may further comprise interrogating, by an electronic reader, the plurality of electrochemical electrodes with respect to the at least one reference electrode using one or more electrochemical measurement modalities to acquire raw sensor data. The method may further comprise transmitting, by the electronic reader, the sensor data to a data processing subsystem. The method may further comprise transforming, by the data processing subsystem, the sensor data into corrected analyte values by applying a trained calibration model configured to compensate for one or more of sensor drift, environmental variability, and cross-ion interference. The method may further comprise outputting the corrected analyte values for real-time monitoring.

In certain examples of the present disclosure, the one or more electrochemical measurement modalities may be selected from potentiometry, voltammetry, impedimetry, and amperometry to acquire the sensor data. In some examples, the method may further comprise exchanging the interchangeable sensor module for another interchangeable sensor module in accordance with a replacement schedule. In certain examples, the replacement schedule may replace a nutrient-sensing module more frequently than a module that senses pH, electrical conductivity, or temperature. In some examples, transforming the sensor data into the corrected analyte values may comprise performing ensemble averaging with outlier rejection across signals from working electrodes that report a same target analyte and continuing to compute the corrected analyte values when fewer than all electrodes of a redundant set remain within predetermined performance thresholds by excluding or down-weighting signals from electrodes that exceed the predetermined performance thresholds. In certain examples, the predetermined performance thresholds may comprise at least one of a maximum permitted drift rate, a maximum calibration residual, a maximum impedance, a maximum noise level, a minimum signal-to-noise ratio, or a minimum inter-electrode agreement. In some examples, the method may further comprise exposing the corrected analyte values through an application programming interface for machine-to-machine integration with an external control system and providing event notifications upon detection of out-of-range conditions.

The foregoing general description of the illustrative embodiments and the following detailed description thereof are merely exemplary aspects of the teachings of this disclosure and are not restrictive.

### BRIEF DESCRIPTION OF FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1A is a block diagram illustrating an exemplary architecture of a modular electrochemical sensing system, as an example of the present disclosure.

FIG. 1B is a block diagram illustrating components of an exemplary sensor module within the sensing system of FIG. 1A.

FIG. 1C is a block diagram illustrating an exemplary architecture of an electronic reader of the sensing system of FIG. 1A.

FIG. 1D is a block diagram illustrating an exemplary architecture of a data processing subsystem of the sensing system of FIG. 1A.

FIG. 2A is a plan view of an exemplary sensor module configured for sensing of multiple analytes, as an example of the present disclosure.

FIGS. 2B-2D are cross-sectional views of the sensor module illustrated in FIG. 2A.

FIGS. 3A and 3B are diagrams of electrode printing display screens used in screen-printing fabrication of sensor modules, as an example of the present disclosure.

FIG. 4A is an exploded view diagram of a printed sensor card showing structural arrangement of electrode components, as an example of the present disclosure.

FIG. 4B is a plan view of the sensor module showing physical layout and electrode arrangement, as an example of the present disclosure.

FIG. 4C is a photograph showing a group of various sensor modules, as an example of the present disclosure.

FIG. 5A is a scatter plot chart showing sensor prediction accuracy for nitrate in salt solutions on a logarithmic scale, as an example of the present disclosure.

FIG. 5B is a scatter plot chart showing sensor prediction accuracy for nitrate in salt solutions on a linear scale, as an example of the present disclosure.

FIG. 5C is a scatter plot chart showing sensor prediction accuracy for nitrate in mixed interfering solutions on a logarithmic scale, as an example of the present disclosure.

FIG. 5D is a scatter plot chart showing sensor prediction accuracy for nitrate in mixed interfering solutions on a linear scale, as an example of the present disclosure.

FIG. 5E is a scatter plot chart comparing nitrate sensor predictions against ground truth measurements, as an example of the present disclosure.

FIG. 5F is a scatter plot chart comparing potassium sensor predictions against ground truth measurements, as an example of the present disclosure.

FIG. 6 is a scatter plot chart showing measurement accuracy across multiple sequential measurements, as an example of the present disclosure.

FIG. 7 is a process flow diagram of an exemplary recirculating hydroponic growing system integrated with sensor nodes of the sensing system for optimizing nutrient balances in controlled environment agriculture according to aspects of the present disclosure.

FIG. 8 is an illustration of an exemplary sensor node deployment in an outdoor soil-based agricultural environment, indicating how sensor nodes of the present disclosure can be installed into outdoor soil-based environments in a variety of formats according to aspects of the present disclosure.

FIG. 9 is a schematic cross-sectional view of an ion-selective membrane architecture configured for multi-analyte detection, as an example of the present disclosure.

FIGS. 10A-10C are perspective views of exemplary handheld portable readers in an operational environment, as an example of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Referring to the figures, the present disclosure relates to a modular electrochemical sensing system configured for real-time monitoring of chemical analytes and physical parameters in aqueous and porous-media environments, including but not limited to hydroponic fluid, soil pore water, plant sap, and environmental water sources. The modular electrochemical sensing system may address challenges associated with conventional laboratory-based analysis, which can involve significant delays for results, as well as challenges associated with existing in-situ sensing technologies that may require frequent recalibration and labor-intensive maintenance. The integration of multiple sensing modalities on a single platform addresses design considerations related to electrode arrangement, signal acquisition, and data processing. The system can monitor multiple analytes simultaneously or near simultaneously while addresses cross-parameter effects and provide mechanisms for maintaining measurement quality over extended deployment periods.

In general, the modular electrochemical sensing system of the present disclosure may provide accessible and low-maintenance sensing through a three-tier architecture comprising one or more interchangeable sensor modules, an electronic reader, and a data processing subsystem. The interchangeable sensor modules may carry a plurality of electrochemical electrodes functionalized with chemically selective membrane material configured to generate electrical responses to target analytes when exposed to a sample, such as a sample of a fluid or porous-media. The electronic reader may acquire signals from the electrochemical electrodes and transmit data representing the acquired signals to the data processing subsystem. The data processing subsystem may transform the data representing the acquired signals into corrected outputs by executing calibration instructions, including trained machine-learning models configured to compensate for measurement drift, environmental variability, and cross-ion interference.

In an aspect, the modular electrochemical sensing system may support continuous in-situ monitoring, periodic automated exposure, and portable spot-checking configurations, providing flexibility for deployment across agriculture, hydroponics, aquaponics, environmental water sources, food and beverage, forestry, chemical manufacturing, mining, and industrial water quality applications. The interchangeable sensor modules may be designed for tool-free insertion and removal from the electronic reader, and may be replaced according to customizable replacement schedules based on the type of analyte being monitored. For example, a nutrient-sensing module configured to monitor ionic species such as nitrate, ammonium, phosphate, and potassium may be replaced more frequently than a module configured to sense pH, electrical conductivity, or temperature.

In an aspect, the data processing subsystem may implement machine-learning algorithms that refine sensor accuracy by compensating for environmental variability, sensor drift, and cross-ion interference. The data processing subsystem may also feature an open application programming interface with support for industry protocols, allowing integration with external control systems such as automated nutrient dosing systems, irrigation controllers, and precision agriculture management platforms. The modular electrochemical sensing system may thereby enable users to make timely, data-driven decisions without waiting for laboratory results, while reducing the maintenance burden associated with conventional electrochemical probes.

The modular electrochemical sensing system of the present disclosure may be applied across a range of monitoring scenarios. In agricultural settings, the system may monitor nutrient levels in soil pore water and irrigation systems to inform fertilization decisions. In hydroponic and aquaponic operations, the system may track nutrient concentrations in recirculating water to maintain optimal growing conditions. The system may also be deployed for environmental water quality monitoring in streams, ponds, and groundwater wells, as well as for wastewater treatment process control. Additional applications may include quality monitoring in food and beverage production, chemical manufacturing process control, and water quality assessment near mining and construction sites. The portable configuration of the system may enable spot-checking measurements in field environments, while fixed installations may provide continuous monitoring for automated control systems.

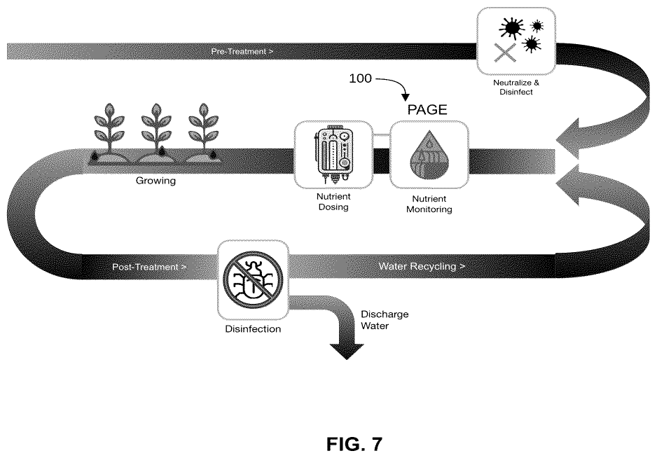

In an example, the sensing system may be integrated into recirculating hydroponic growing systems for optimizing nutrient balances in controlled environment agriculture, as seen in FIG. 7. In such applications, one or more sensor nodes may be positioned at multiple points within the recirculating system to monitor source water parameters, plant nutrient uptake, leachate, and outflow. As shown in FIG. 7, the sensing system may be positioned at a nutrient monitoring location within the recirculation loop, enabling real-time tracking of nutrient parameters such as nitrate, potassium, pH, and electrical conductivity. The data acquired by the sensor nodes may be transmitted to a data processing subsystem, which may generate corrected analyte values that inform adjustments to a nutrient dosing system to maintain conditions suitable for plant growth throughout the recirculating hydroponic system.

With continued reference to FIG. 7, the sensing system may be installed as an in-line continuous monitoring system for hydroponics, soil, and water applications. In some cases, the sensing system 100 may include an actuation mechanism configured to control exposure to water when measurements are taken on demand or at a scheduled frequency. The actuation mechanism may retract or shield the sensor nodes from the fluid stream between measurement intervals, thereby reducing fouling and extending the operational lifetime of the sensor nodes. In some cases, the sensing system 100 may be part of an automated sampling system that extracts samples on a periodic basis, such as hourly or daily, for analysis by the sensor nodes.

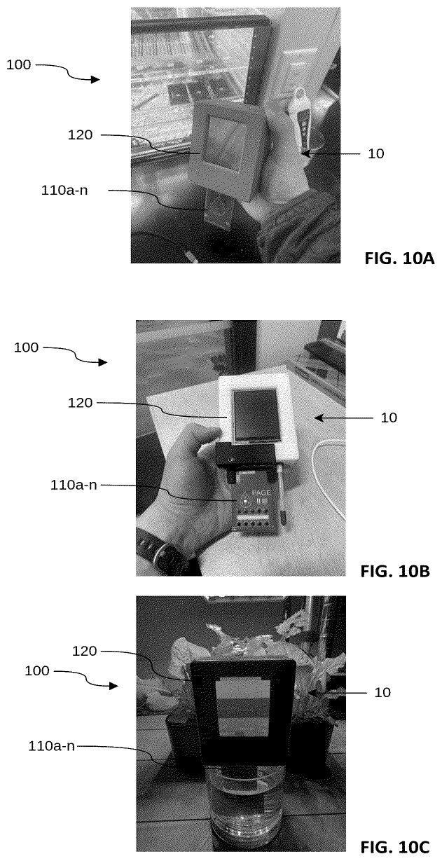

The sensing system may also be deployed as a handheld portable device (FIGS. 10A-10C) for spot-checking applications. In such configurations, a user may carry the sensing system 100 to various locations within a growing facility or field environment to obtain on-the-go nutrient and water quality measurements. The handheld portable device configuration may allow users to perform rapid assessments without the infrastructure associated with fixed installation systems.

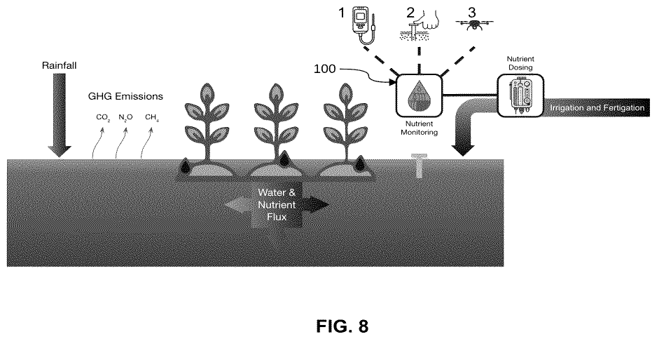

In another example, the sensing system may be installed into outdoor soil-based agricultural environments in a variety of deployment formats, as seen in FIG. 8. As shown in FIG. 8, three deployment formats are illustrated for the sensor nodes. A first deployment format can comprises a handheld portable probe for spot-checking measurements in soil or irrigation water. A second deployment format can comprise a sprinkler-mounted or irrigation-mounted sensor head for in-situ monitoring of soil conditions over extended periods. A third deployment format can comprise a drone or unmanned aerial vehicle for aerial sensor deployment and data collection across large agricultural areas. With continued reference to FIG. 8, the sensing system may support mechanized deployment including mounting on unmanned aerial vehicles, unmanned ground vehicles, and manned ground vehicles such as tractors or other land management equipment. Such mechanized deployment configurations may enable automated sensor reading across large-scale agricultural operations, reducing the labor associated with manual sampling and measurement.

In some cases, deployment ports may be installed for long-term durations into the ground to provide sampling access for the sensor nodes of the system. The deployment ports may include a fine mesh configured to prevent solid-mass transfer into the port while permitting fluid communication with the surrounding soil pore water. The deployment ports may be physically covered by a screw or hatch mechanism that can be opened manually by a user. In some cases, the port cover may be configured to open automatically when sensing a nearby paired electronic reader, thereby facilitating automated measurement sequences without manual intervention.

Beyond agricultural applications, the sensing system may be adapted for detecting contaminants in wastewater systems, monitoring chemical manufacturing processes, and ensuring quality control in food and beverage production. In wastewater management applications, the sensor modules 110a-n may be configured to monitor nutrient levels, pH, and other parameters relevant to treatment processes and regulatory compliance. In chemical manufacturing and food and beverage production, the sensing system 100 may provide real-time monitoring of process water quality and product parameters.

The sensing system may also be adapted for environmental water quality monitoring near mining operations and other construction sites, where tracking of nutrients, contaminants, and pollutants may inform watershed protection and regulatory compliance efforts. In such applications, the sensor modules 110a-n may be deployed in streams, ponds, or groundwater monitoring wells to acquire data on water quality parameters over time.

In some cases, the sensing system may be modified for point-of-care biosensing applications, enabling rapid detection of biomarkers, metabolites, and pathogens in medical diagnostics. The modular architecture of the sensing system may allow the sensor modules to be functionalized with chemically selective membrane materials or molecularly imprinted polymers configured to interact with biological analytes of interest.

The sensing system may also be deployed for air and water quality monitoring in smart city infrastructure, contributing to environmental health and safety initiatives. In such deployments, the sensing system may be networked with other monitoring systems and integrated with centralized data platforms through the open application programming interface of the data processing subsystem.

In an aspect, the present disclosure provides a modular electrochemical sensing system configured for monitoring chemical analytes and physical parameters in fluid or porous-media samples. The modular electrochemical sensing system may comprise one or more interchangeable sensor modules, an electronic reader, and a data processing subsystem. Each interchangeable sensor module may comprise a substrate carrying a plurality of electrochemical electrodes. The plurality of electrochemical electrodes may comprise a plurality of working electrodes and at least one reference electrode. One or more of the plurality of working electrodes may comprise chemically selective membrane material that generates respective electrical responses to respective target analytes when exposed to a fluid or porous-media sample. The electronic reader may comprise a module interface configured to removably connect with the one or more interchangeable sensor modules. The electronic reader may comprise measurement circuitry configured to acquire signals from the plurality of working electrodes with respect to the at least one reference electrode. The electronic reader may comprise a communication interface configured to transmit data representing the acquired signals. The data processing subsystem may be operatively coupled to the electronic reader. The data processing subsystem may comprise one or more processors and memory storing calibration instructions that, when executed by the one or more processors, transform the data representing the acquired signals into corrected outputs.

As used herein, the term “fluid or porous-media sample” or sample of fluid or porous media refers to a sample comprising a liquid, a gas, or a material having interstitial spaces through which fluids may permeate, including but not limited to aqueous solutions, hydroponic nutrient solutions, soil pore water, plant sap, wastewater, environmental water from streams, ponds, or groundwater wells, industrial process water, cooling tower water, boiler feedwater, desalination brine, fermentation broth, beverage products, dairy products, pharmaceutical solutions, blood serum, urine, saliva, interstitial fluid, cerebrospinal fluid, mine drainage, leachate from landfills, stormwater runoff, swimming pool water, aquarium water, fish tank water, wetland water, estuarine water, seawater, brackish water, geothermal fluids, oil field produced water, fracking flowback water, compost leachate, vermicompost extract, biochar slurry, peat extracts, sand, gravel, clay, loam, vermiculite, perlite, rockwool, coco coir, grow media, biofilms, sediments, sludge, and other media containing chemical analytes or physical parameters to be monitored.

In an aspect, the present disclosure provides a replaceable sensor module configured for use with a reader device. The replaceable sensor module may comprise a substrate carrying conductive structures that define electrical interconnects and a reader interface region configured to releasably mate with a reader device. A plurality of electrochemical electrodes may be disposed on the substrate and electrically coupled to the electrical interconnects. The plurality of electrochemical electrodes may comprise a plurality of working electrodes comprising a first redundant group of two or more substantially similar ion-selective electrodes. Each ion-selective electrode of the first redundant group may include chemically selective membrane material configured to generate an electrical response to a first target analyte when exposed to a fluid or porous-media sample. The plurality of electrochemical electrodes may further comprise at least one reference electrode comprising a reference couple in ionic communication with an electrolyte reservoir. The at least one reference electrode may be covered by at least one ion-permeable polymeric barrier layer configured to regulate ion exchange to maintain reference-potential stability and reduce drift during exposure to a sample of a fluid or porous-media. The replaceable sensor module may further comprise a protective encapsulation layer overlying at least a portion of the conductive structures. The protective encapsulation layer may define openings that expose active surfaces of the plurality of electrochemical electrodes while inhibiting fluid ingress to the conductive structures.

In an aspect, the present disclosure provides a method for monitoring chemical analytes and physical parameters in fluid or porous-media. The method may comprise contacting an interchangeable sensor module with a sample of the fluid or porous-media. The interchangeable sensor module may comprise a plurality of electrochemical electrodes. The plurality of electrochemical electrodes may comprise at least one reference electrode and a plurality of working electrodes functionalized with chemically selective membrane material configured to generate respective electrical responses to one or more target analytes of the sample. The method may further comprise interrogating, by an electronic reader, the plurality of electrochemical electrodes with respect to the at least one reference electrode using one or more electrochemical measurement modalities to acquire raw sensor data. The method may further comprise transmitting, by the electronic reader, the sensor data to a data processing subsystem. The method may further comprise transforming, by the data processing subsystem, the sensor data into corrected analyte values by applying a trained calibration model configured to compensate for one or more of sensor drift, environmental variability, and cross-ion interference. The method may further comprise outputting the corrected analyte values for real-time monitoring.

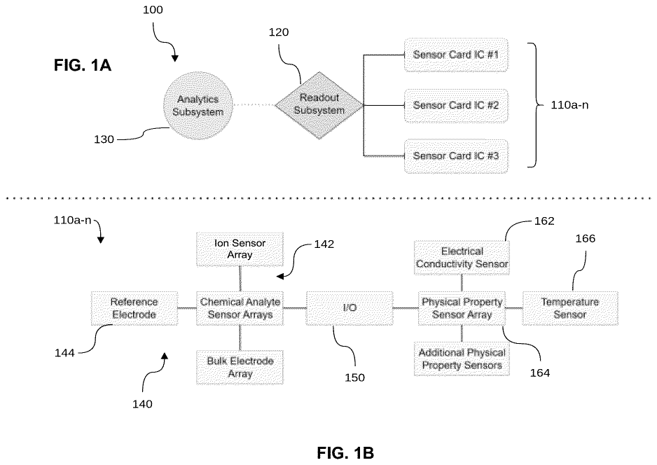

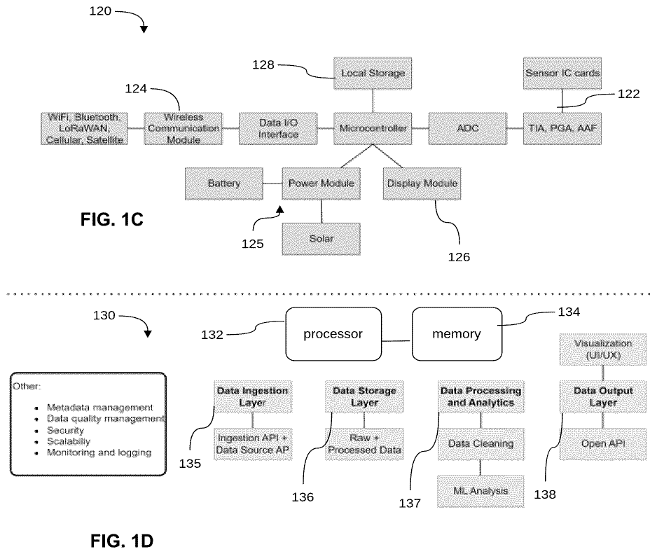

Referring now to the figures, FIG. 1A illustrates an exemplary architecture of the modular electrochemical sensing system 100, depicting the three-tier hierarchical configuration of the system comprising interchangeable sensor modules 110a-n, an electronic reader 120, and a data processing subsystem 130. In an example, each sensor module 110a-n is a printed sensor card. The electronic reader 120 is configured to removably receive one of the interchangeable sensor modules 110a-n and is operatively coupled to the data processing subsystem 130. The number of sensor modules 110a-n may vary depending on the application requirements. The three-tier architecture may enable replaceable sensor modules 110a-n to feed signals into the electronic reader 120, which in turn transmits data to the data processing subsystem 130 for processing and analysis.

With continued reference to FIG. 1A, the sensor modules 110a-n may be deployed at different depths in various environments to enable stratified data collection. For example, in soil monitoring applications, multiple sensor modules 110a-n may be positioned at different soil depths to acquire data on nutrient concentrations and moisture levels throughout a soil profile. In hydroponic applications, sensor modules 110a-n may be positioned at different locations within a recirculating fluid system to monitor nutrient uptake and leachate characteristics or the like.

FIG. 1B illustrates components of an exemplary sensor module 110a-n of the sensing system 100 of FIG. 1A, showing the integration of chemical analyte sensing and physical property sensing capabilities on a single interchangeable substrate. Each sensor module 110a-n may include two main functional groupings, chemical and physical, connected by a central input/output interface 150. Each sensor module 110a-n may include a plurality of electrochemical electrodes 140 including working electrodes 142 functionalized with chemically selective membrane material and a reference electrode. In an example, the working electrodes 142 may comprise an ion sensor array, chemical analyte sensor arrays, and/or a bulk electrode array.

As further shown in FIG. 1B, each sensor module 110a-n may include an electrical conductivity sensor 162, physical property sensors 164, and/or additional physical property sensors. The input/output interface 150 provides connectivity between the two functional groupings and the electronic reader 120. FIG. 1B illustrates how each sensor module 110a-n may integrate both chemical analyte sensing and physical property sensing capabilities on a single interchangeable substrate. The sensor module 110a-n may integrate commercial sensors for temperature, e.g. temperature sensor 166, electrical conductivity, oxidation-reduction potential, and turbidity, allowing for a customizable and expandable sensing platform. The physical property sensors 164 may include commercially available sensor components that complement the electrochemical sensing electrodes 140 to provide a comprehensive set of measurements for a given application. The electrical conductivity sensors 162 may measure the ionic strength of a sample, while the temperature sensor 166 may provide temperature compensation data for the electrochemical measurements. The modular architecture of the sensor module 110a-n may allow different sensor types to be combined on a single substrate to address the monitoring requirements of a particular deployment environment.

FIG. 1C illustrates an exemplary architecture of the electronic reader 120, depicting a microcontroller 127 as a central processing hub connected to peripheral blocks including local storage 128, a wireless communication interface 124, signal conditioning circuitry, a module interface 122, a power module 125, and a display module 126.

With continued reference to FIG. 1C, the electronic reader 120 of the sensing system 100 may include a microcontroller 127 that serves as a central processing hub for real-time signal processing, calibration, and control logic. The microcontroller 127 may be connected to multiple peripheral blocks that together enable data acquisition, storage, communication, and power management functions. The electronic reader 120 may handle real-time signal processing and calibration operations, and may execute machine-learning-driven accuracy enhancements locally or in coordination with the data processing subsystem 130. The electronic reader 120 may include a module interface 122 where the interchangeable sensor modules 110a-n connect to the reader electronics. The module interface 122 may comprise, for example, spring-loaded contacts, conductive pads, or a flexible connector configured to permit tool-free insertion and removal of the one or more interchangeable sensor modules 110a-n. The module interface 122 may support multi-sensor integration and may enhance reliability while minimizing installation complexity. In some cases, the electronic reader 120 may include custom breakout boards to enable seamless connection to the sensor modules 110a-n and environmental interfaces.

As further shown in FIG. 1C, the electronic reader 120 may include signal conditioning circuitry connected to the module interface 122. The signal conditioning circuitry may comprise a transimpedance amplifier, a programmable gain amplifier, and an anti-aliasing filter, which together condition raw analog signals from the electrochemical sensing electrodes 140 before digitization. An analog-to-digital converter may be connected to the signal conditioning circuitry and may digitize the conditioned signals for processing by the microcontroller 127. In some cases, the electronic reader 120 may include a customized potentiostat module or may incorporate a commercially-available potentiostat module for executing electrochemical measurement protocols. In some cases, the electronic reader 120 may include basic electronic components and an analog-to-digital converter without a dedicated potentiostat module.

The electronic reader 120 may include a local storage 128 connected to the microcontroller 127. The local storage 128 may provide data buffering capability when wireless connectivity is unavailable. The local storage 128 may comprise a flash or RAM module configured to store data locally until transmission to the data processing subsystem 130 can be completed.

With continued reference to FIG. 1C, the electronic reader 120 may include a display module 126 connected to the microcontroller 127. The display module 126 may provide local visualization capability for real-time monitoring and spot checks. In some cases, the display module 126 may comprise a touchscreen display. In some cases, the display module 126 may comprise a non-touchscreen display with physical buttons embedded in the reader chassis.

The electronic reader 120 may include a power module 125 connected to the microcontroller 127. The power module 125 may support both primary and secondary batteries for portable or off-grid operation. The power module 125 may be paired with energy harvesters such as solar cell configurations for long-term autonomous field deployment. In some cases, the power module 125 may include a port for wired charging of the battery. Power optimization algorithms may be used to extend operational life in off-grid environments.

As further shown in FIG. 1C, the electronic reader 120 may include a wireless communication interface 124 connected to the microcontroller 127 via a data input/output interface. The wireless communication interface 124 may comprise a wireless communication module configured to wirelessly transmit the data to the data processing subsystem 130. The wireless communication interface 124 may support multiple wireless protocols including WiFi, Bluetooth, LoRaWAN, cellular, and satellite connectivity. The LoRaWAN protocol may enable long-range, low-power communication in remote field deployments. Satellite connectivity may enable off-grid autonomous operation in locations without cellular or WiFi coverage. In some cases, the electronic reader 120 may include a port for wired data transfer in addition to wireless communication.

The electronic reader 120 may be configured as a transportable handheld device for portable spot-checking applications, such as seen in FIGS. 10A-10C. In such configurations, a user may carry the electronic reader 120 to various locations to obtain on-the-go measurements. In some cases, the electronic reader 120 may be deployed for continuous monitoring applications by mechanical mounting and/or insertion in the environment. The electronic reader 120 may thereby support both portable and fixed deployment scenarios depending on the monitoring requirements of a particular application.

FIG. 1D illustrates an exemplary architecture of the data processing subsystem 130, depicting functional layers including a data ingestion layer 135, a data storage layer 136, a data processing and analytics 137 layer, and a data output layer 138. The data processing subsystem 130 receives sensor data from the electronic reader 120 and applies trained machine-learning models to transform raw sensor signals into corrected analyte values that can be outputted.

As seen in FIG. 1D, the data processing subsystem 130 may comprise one or more processors 132 and memory 134 storing calibration instructions that, when executed by the one or more processors 132, transform the data representing the acquired signals into corrected outputs. The data processing subsystem 130 may be implemented as a cloud-based system, a local computing system, or a hybrid configuration that combines local and cloud processing capabilities. In some cases, the data processing subsystem 130 may perform edge computing on the microcontroller 127 of the electronic reader 120 to pre-transform raw sensor data into physical parameters prior to cloud upload. In some cases, the data processing subsystem 130 may operate in a hybrid local-plus-cloud processing mode where initial signal conditioning and parameter computation occur on the electronic reader 120 while advanced analytics and machine-learning inference occur on cloud infrastructure. In some cases, the data processing subsystem 130 may operate in a cloud-only pipeline mode where raw sensor data is transmitted directly to cloud infrastructure for processing.

The data processing subsystem 130 may comprise data ingestion layer 135 configured to receive sensor data from the electronic reader 120. The data ingestion layer 135 may include an ingestion application programming interface and a data source access point for receiving sensor data in real time or on a scheduled basis. The data ingestion layer 135 may handle real-time data ingestion and may securely transfer readings to downstream processing and storage components.

The data processing subsystem 130 may comprise a data storage layer 136 configured to store raw and processed sensor data. The data storage layer 136 may comprise a relational database or other structured storage system for retaining sensor readings, processed outputs, and associated metadata. The data storage layer 136 may retain raw and processed sensor data and metadata for historical analysis and trend detection. The data storage layer 136 may enable retrieval of historical measurements for comparison with current readings and for training or retraining of machine-learning models.

The data processing subsystem 130 may comprise a data processing and analytics 137 layer configured to transform raw sensor data into corrected analyte values. The data processing and analytics 137 layer may include data cleaning components that filter noise, remove outliers, and normalize signals prior to calibration model application. The data processing and analytics 137 layer may implement a trained machine-learning model configured to compensate for measurement drift and cross-parameter interference to generate the corrected outputs in real-time. The trained machine-learning model may be trained on mixtures of known composition to improve measurement accuracy in complex media where interfering species may otherwise degrade sensor performance. The trained machine-learning model may dynamically adjust calibration to compensate for sensor degradation and environmental variations over time.

The trained machine-learning model may perform ensemble averaging with outlier rejection across signals from electrodes that report a same analyte. The trained machine-learning model may assign quality scores to individual electrode signals for selective weighting. The quality scores may reflect factors such as signal stability, noise level, drift rate, and agreement with other electrodes in a redundant group. Signals from electrodes with higher quality scores may receive greater weight in the ensemble average, while signals from electrodes with lower quality scores may be down-weighted or excluded from the computation. The ensemble averaging with outlier rejection may enable the data processing subsystem 130 to continue providing corrected outputs when fewer than all electrodes of a redundant group remain within predetermined performance thresholds.

In some examples, the quality scores may be computed as a composite metric derived from multiple performance indicators associated with each electrode signal. The computation may incorporate drift rate deviation from a baseline established during conditioning, where electrodes exhibiting drift rates closer to zero may receive higher score contributions. Noise variance measured over a sliding window may contribute to the quality score, with lower noise variance corresponding to higher score contributions. Calibration residual magnitude, representing the deviation between measured signals and expected signals based on stored calibration parameters, may also factor into the quality score computation. Impedance values relative to initial impedance measurements recorded during conditioning may indicate membrane integrity, with impedance ratios closer to unity contributing to higher scores. Signal-to-noise ratio computed from recent measurement intervals may provide an additional score component, with higher signal-to-noise ratios corresponding to higher quality scores. Inter-electrode correlation coefficients computed across electrodes within a redundant group may reflect agreement among electrodes measuring the same analyte, with higher correlation contributing to higher scores. In some cases, the individual metric contributions may be normalized to a common scale, such as a zero-to-one range, before combination. Weighting factors may be applied to different metrics based on application requirements, allowing the quality score computation to emphasize metrics most relevant to a particular deployment environment. The quality scores may be updated dynamically as new measurements are acquired, enabling the data processing subsystem to adapt electrode weighting in response to changing electrode performance characteristics over time.

The data processing and analytics 137 layer may incorporate anomaly detection that flags potential sensor failures or unexpected environmental changes. The anomaly detection may identify readings that deviate from expected patterns based on historical data, calibration models, or inter-electrode agreement metrics. When anomalies are detected, the data processing subsystem 130 may generate alerts or event notifications to inform users or connected systems of the condition.

The data processing and analytics 137 layer may integrate multi-sensor data fusion techniques that incorporate additional variables such as weather data, soil conditions, and historical measurements to improve measurement reliability. The multi-sensor data fusion may combine electrochemical sensor readings with data from the temperature sensor 166, the electrical conductivity sensors 162, and the physical property sensors 164 to provide context for analyte concentration estimates. External data sources such as weather stations or soil moisture sensors may also be incorporated into the fusion model to account for environmental factors that affect sensor response.

The data processing subsystem 130 may comprise a data output layer 138 configured to expose corrected analyte values to users and external systems. The data output layer 138 may connect to an open application programming interface for machine-to-machine integration with external control systems. The open application programming interface may support industrial protocols including BACnet and Modbus for machine-to-machine integration with industrial and agricultural infrastructure. The open application programming interface may allow the corrected analyte values to flow into automated nutrient dosing systems, irrigation controllers, precision agriculture platforms, and other data-driven decision-making systems.

The data output layer 138 may provide event notifications upon detection of out-of-range conditions. The event notifications may be transmitted to users via email, text message, or push notification, or may be transmitted to external control systems via the open application programming interface. The event notifications may enable timely response to conditions that require intervention, such as nutrient deficiencies, pH excursions, or sensor malfunctions.

The data output layer 138 may connect to a visualization interface for presenting corrected analyte values to users. The data processing subsystem 130 may provide a web-based dashboard for real-time monitoring, analytics, and visualizations. The web-based dashboard may display current sensor readings, historical trends, alert status, and system health indicators. Users may access the web-based dashboard from desktop computers, tablets, or mobile devices to monitor conditions and review data from remote locations.

The data processing subsystem 130 may further provide user authentication and access control mechanisms to secure sensor data and system configurations. Role-based access controls may allow administrators to define permissions for different user types, enabling appropriate access to monitoring data, configuration settings, and system management functions.

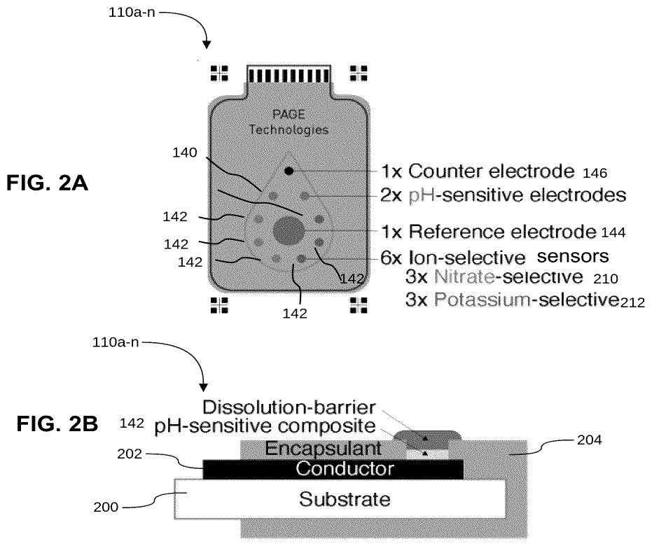

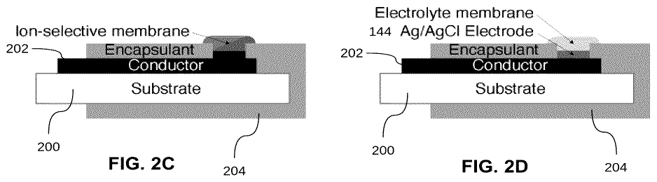

FIG. 2A illustrates a plan view of an exemplary sensor module 110a-n configured for redundant sensing of multiple analytes, showing the spatial arrangement of electrochemical electrodes within a teardrop-shaped sensing region on a substrate 200. The sensor module 110a-n includes a substrate 200 carrying a plurality of electrochemical electrodes arranged in a spatial configuration within a teardrop-shaped sensing region. A reader interface 112 is defined at the top edge of the sensor module 110a-n and comprises a row of conductive contact pads configured to engage corresponding contacts of the electronic reader 120. The reader interface 112 provides electrical connectivity between the electrochemical sensing electrodes 140 disposed within the sensing region and the module interface 122 of the electronic reader 120.

As further shown in FIG. 2A, a counter electrode 146 is disposed on the substrate 200 in an upper portion of the sensing region. The counter electrode 146 is electrically coupled to the electrical interconnects that route signals to the reader interface 112. The counter electrode 146 may complete three-electrode circuits for voltammetric and amperometric interrogation modes, enabling current to flow between the working electrodes 142 and the counter electrode 146 while maintaining a stable potential at the reference electrode 144.

With continued reference to FIG. 2A, two pH-sensitive 148 electrodes are disposed below the counter electrode 146, providing same-analyte redundancy for pH measurement. The pH-sensitive 148 electrodes may comprise composite electrodes incorporating pH-sensitive dyes such as Alizarin. The pH-sensitive dyes may be premixed into a carbon ink before printing, polymerized onto the electrode surface, or drop-casted to create a functionalized sensing layer. The pH-sensitive dye concentration in the composite electrode may range from 5 to 25 wt % for sufficient sensing response while maintaining ink viscosity and printability for scalable manufacturing. The pH-sensitive 148 electrodes may be coated with protective membrane layers such as Nafion or other polymeric films to reduce interference from non-target ions and minimize drift over time. In some cases, the pH-sensitive 148 electrodes may incorporate hydrogen-selective membranes for direct proton detection with or without ionophores.

As further shown in FIG. 2A, the reference electrode 144 is centrally positioned within the sensing region of the sensor module 110a-n. The central placement of the reference electrode 144 provides a stable potential baseline for all electrochemical measurements and reduces potential gradients among the surrounding working electrodes 142.

With continued reference to FIG. 2A, the working electrodes 142 include six ion-selective sensors arranged around the reference electrode 144. Three nitrate-selective electrodes 210 are disposed on one side of the reference electrode 144, and three potassium-selective electrodes 212 are disposed on the opposite side of the reference electrode 144. Each of the nitrate-selective electrodes 210 and the potassium-selective electrodes 212 is functionalized with chemically selective membrane material configured to generate electrical responses to respective target analytes when exposed to a fluid or porous-media sample. The arrangement of multiple substantially similar electrodes for each target analyte provides same-analyte redundancy that enables ensemble averaging and outlier rejection by the data processing subsystem 130.

The working electrodes 142 may have electrode sizes ranging from 10 micrometers to 10 mm in diameter, providing flexibility for different deployment configurations and sensitivity requirements. The working electrodes 142 may be fabricated from gold-plated copper or printed carbon allotropes, depending on the fabrication approach and performance requirements of a particular application.

As described previously, each interchangeable sensor module 110a-n may further comprise additional working electrodes configured to generate electrical responses indicative of pH and electrical conductivity. The sensor module 110a-n may further comprise at least one additional working electrode selected from an ion-selective electrode for a second target analyte different from the first target analyte of the first redundant group, a pH-sensitive electrode, and an electrical-conductivity sensing structure formed by a pair of spaced electrodes.

The electrical conductivity sensors 162 may comprise two parallel electrodes forming an interdigitated pattern or space-filling electrodes. The electrical conductivity sensors 162 may have electrode sizes ranging from 10 micrometers to 10 mm and spacing between 10 micrometers and 10 mm apart, depending on the application requirements. The electrical conductivity sensors 162 may be fabricated from printed conductive materials such as carbon, Ag/AgCl, or constructed using copper or gold-plated copper PCB designs. An encapsulation or dielectric layer may be deposited on top of the electrodes of the electrical conductivity sensors 162 to define the sensing geometry. Electrical conductivity measurement may be performed using impedance spectroscopy or solution resistance methods, where the sensor response is influenced by the electrode size, spacing, and surrounding medium.

As described previously, the sensor module 110a-n may further comprise one or more of the temperature sensor 166, the electrical conductivity sensors 162, and the physical property sensors 164. The integration of these sensors on the substrate 200 alongside the electrochemical sensing electrodes 140 enables comprehensive monitoring of both chemical analytes and physical parameters within a single interchangeable sensor module 110a-n.

FIGS. 2B-2D illustrate cross-sectional views of the sensor module 110a-n of FIG. 2A, depicting the layered electrode architectures for different electrode types. FIG. 2B illustrates a cross-sectional view of a pH-sensitive electrode, showing a dissolution-barrier pH-sensitive composite disposed on the conductive structures 202 within an opening defined by the protective encapsulation layer 204. FIG. 2C illustrates a cross-sectional view of an ion-selective electrode, showing an ion-selective membrane disposed on the conductive structures 202 and configured to generate an electrical response to a target analyte. FIG. 2D illustrates a cross-sectional view of the reference electrode 144, showing a silver/silver-chloride electrode disposed on the conductive structures 202 and covered by an electrolyte membrane configured to regulate ion flux and maintain reference-potential stability. Each cross-sectional view depicts the common structural arrangement comprising the substrate 200, conductive structures 202, and protective encapsulation layer 204, while illustrating the distinct functional layers that differentiate the electrode types.

Referring now to FIGS. 2C-2D, the cross-sectional architectures of the electrochemical sensing electrodes 140 disposed on the sensor module 110a-n are described in further detail. Each electrode type shares a common structural foundation comprising the substrate 200, the conductive structures 202, and the protective encapsulation layer 204, while differing in the functional layers that determine the electrode's role within the modular electrochemical sensing system 100.

FIG. 2C illustrates a cross-sectional view of an ion-selective electrode of the working electrodes 142. The substrate 200 forms the base layer of the electrode structure and provides mechanical support for the overlying layers. The conductive structures 202 are disposed on the substrate 200 and form a conductor layer that provides electrical connectivity between the ion-selective electrode and the reader interface 112. The conductive structures 202 may comprise plated gold, carbon, silver, AgCl, organic conductors, or copper, depending on the fabrication approach and performance requirements of a particular application. The protective encapsulation layer 204 overlies portions of the conductive structures 202 and defines an opening that exposes an active electrode region. Within the opening, an ion-selective membrane is disposed on the conductive structures 202, forming one of the working electrodes 142. The ion-selective membrane includes chemically selective membrane material configured to generate an electrical response to a target analyte when exposed to a fluid or porous-media sample. The protective encapsulation layer 204 protects the underlying conductive structures 202 from fluid ingress while exposing the active sensing surface of the ion-selective membrane to the sample.

With continued reference to FIG. 2C, the protective encapsulation layer 204 inhibits fluid from reaching the conductive traces that route signals from the electrochemical sensing electrodes 140 to the reader interface 112. By defining openings that expose the active surfaces of the plurality of electrochemical electrodes while covering the non-active portions of the conductive structures 202, the protective encapsulation layer 204 prevents shorting of the printed traces when the sensor module 110a-n is immersed in a fluid sample. The geometry of the openings in the protective encapsulation layer 204 is registered to each electrode type to accommodate the different active-area requirements of ion-selective electrodes, pH-sensitive 148 electrodes, and the electrical conductivity sensors 162.

FIG. 2D illustrates a cross-sectional view of the reference electrode 144 of the sensor module 110a-n. The substrate 200 forms the base layer, and the conductive structures 202 are disposed on the substrate 200 to form a conductor layer. The protective encapsulation layer 204 overlies portions of the conductive structures 202 and defines an opening that exposes an active electrode region. Within the opening, a silver/silver-chloride electrode is disposed on the conductive structures 202, providing a reference couple for electrochemical measurements. As described previously, the reference electrode 144 comprises a silver/silver-chloride reference couple in ionic communication with an electrolyte reservoir. An electrolyte membrane covers the silver/silver-chloride electrode and is configured to regulate ion flux between an internal electrolyte reservoir and the external sample environment, thereby maintaining reference-potential stability and reducing drift during exposure to fluid or porous-media samples.

As further shown in FIG. 2D, the reference electrode 144 is covered by at least one ion-permeable polymeric membrane configured to regulate ion flux to maintain reference-potential stability and reduce drift. The ion-permeable polymeric membrane may comprise polyvinyl butyral or hydrogel-based formulations, which enhance ion exchange efficiency and sensor longevity. The ion-permeable polymeric membrane controls exchange with the external medium so that sudden changes in sample composition do not directly perturb the silver/silver-chloride reference couple, thereby stabilizing the reference potential during extended exposure to fluid or porous-media samples.

In some cases, the at least one ion-permeable polymeric membrane and the electrolyte reservoir may define multiple diffusion pathways via slits or multiple wells. The multiple diffusion pathways may distribute mass transport and dampen transients, thereby further stabilizing the reference potential during prolonged exposure to samples with varying ionic strength and temperature. The slits or multiple wells may tune the ion-exchange rate to optimize stability across diverse operating conditions encountered in field deployments.

In certain examples, slits may comprise narrow openings cut or patterned into the ion-permeable polymeric membrane or the underlying electrode structure. The slits may create additional pathways for ion exchange between the electrolyte reservoir and the sample solution, thereby increasing the effective surface area available for ion diffusion. The slits may have widths ranging from approximately 10 micrometers to approximately 500 micrometers and lengths ranging from approximately 100 micrometers to approximately 5 millimeters, depending on the electrode geometry and the desired ion-exchange rate. In some cases, the slits may be arranged in a radial pattern extending outward from a central region of the reference electrode, or may be arranged in parallel lines across the electrode surface.

In some examples, multiple wells may comprise discrete pockets or cavities formed in the ion-permeable polymeric membrane or the electrolyte reservoir structure. Each well may hold a portion of the electrolyte and may provide a separate diffusion zone through which ions exchange with the sample environment. The wells may have diameters ranging from approximately 50 micrometers to approximately 1 millimeter and depths ranging from approximately 10 micrometers to approximately 500 micrometers. The wells may be distributed across the electrode surface in a regular array pattern or in a randomized distribution to optimize ion-exchange uniformity.

The slits and wells may function to distribute ion exchange more evenly across the electrode surface, reducing localized depletion of the electrolyte reservoir that could otherwise cause spatial variations in reference potential. By providing multiple discrete diffusion pathways, the slits and wells may dampen transient perturbations caused by sudden changes in sample composition, thereby stabilizing the reference potential during extended exposure to samples with varying ionic strength and temperature. The distributed diffusion pathways may also reduce the rate of electrolyte depletion at any single location, extending the operational lifetime of the reference electrode.

In certain examples, the slits and wells may be formed during the screen-printing fabrication process by incorporating corresponding features into the printing screens used to deposit the ion-permeable polymeric membrane or electrolyte reservoir layers. In some cases, the slits and wells may be formed through laser ablation, mechanical cutting, or photolithographic patterning after deposition of the membrane or reservoir layers. The fabrication approach may be selected based on the desired feature dimensions, the membrane material properties, and the production volume requirements of a particular application.

The reference electrode 144 may incorporate self-contained salt reservoirs to minimize recalibration requirements or enable calibration-free sensor configurations. The self-contained salt reservoirs may maintain a stable chloride activity internal to the reference couple over extended deployment periods, reducing the frequency of recalibration interventions. In some cases, the reference electrode 144 may incorporate redundant reference electrodes on the same sensor module 110a-n to provide fallback if one reference electrode drifts or fails. The redundant reference electrodes may enable the data processing subsystem 130 to adjust calibration parameters and continue providing corrected outputs when one reference electrode exceeds predetermined performance thresholds.

The reference electrode 144 may use through-hole mounting, spring-loaded contact pins, card edge connectors, or flexible interfaces for electrical interfacing with the electronic reader 120. The electrical interfacing mechanism may ensure robust reader connectivity across different form factors while preserving the ionic pathway between the electrolyte reservoir and the sample through the ion-permeable polymeric membrane. As described previously, the reader interface 112 comprises a plurality of conductive pads arranged to engage corresponding contacts of the reader device. The conductive pads of the reader interface 112 provide electrical connectivity between the reference electrode 144 and the module interface 122 of the electronic reader 120.

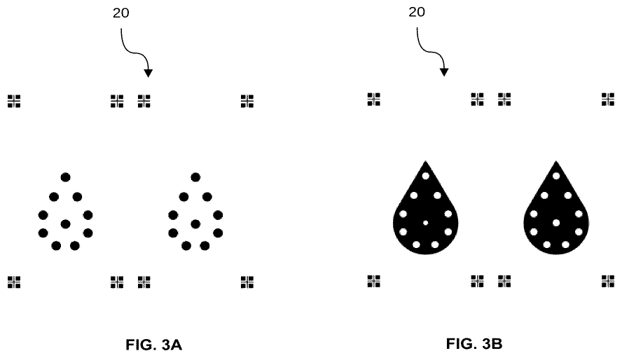

Referring now to FIGS. 3A and 3B, the screen-printing fabrication process for manufacturing the sensor modules 110a-n is described. The sensor modules 110a-n may be manufactured using screen printing, inkjet printing, gravure printing, flexographic printing, aerosol jet printing, or 3D printing. In the screen-printing approach, a display screen 20 is used to deposit materials onto the substrate 200 in a controlled pattern. The screen-printing fabrication process may employ multiple display screens 20 in a sequential printing process, where each display screen 20 deposits a different material layer to build up the complete sensor module 110a-n structure.

FIG. 3A illustrates an electrode printing screen used in the screen-printing fabrication of the sensor modules 110a-n. The electrode printing screen comprises a display screen 20 that includes two side-by-side teardrop-shaped electrode patterns. Each teardrop-shaped electrode pattern comprises a plurality of circular openings arranged in a spatial configuration corresponding to the positions of the electrochemical sensing electrodes 140 on the finished sensor module 110a-n. The circular openings in each pattern correspond to the active electrode sites, including positions for the working electrodes 142, the reference electrode 144, the counter electrode 146, and the pH-sensitive 148 electrodes. Alignment marks are positioned at the corners of the display screen 20 to ensure registration accuracy during the printing process.

With continued reference to FIG. 3A, when conductive ink is forced through the openings of the electrode printing screen onto the substrate 200, the ink deposits the complete conductive structures 202 including electrode pads and interconnect traces in a single printing pass. The conductive ink may comprise carbon-based inks, silver inks, silver/silver-chloride inks, or gold inks, depending on the electrode type and performance requirements. The electrode printing screen enables parallel fabrication of multiple sensor modules 110a-n on a single substrate 200, as illustrated by the two side-by-side electrode patterns on the display screen 20. The parallel fabrication approach may reduce manufacturing time and cost by producing multiple sensor modules 110a-n simultaneously.

FIG. 3B illustrates an encapsulation printing screen used in the screen-printing fabrication of the sensor modules 110a-n. The encapsulation printing screen comprises a display screen 20 that includes two side-by-side solid teardrop-shaped regions. Each solid teardrop-shaped region represents the protective encapsulation layer 204 material with a plurality of circular openings that expose the active sensing surfaces of each electrode. The solid teardrop-shaped regions define the areas where encapsulant material is deposited over the conductive structures 202 and non-active portions of the substrate 200, while the circular openings within each teardrop shape leave the active electrode surfaces exposed to a sample.

As further shown in FIG. 3B, alignment marks are positioned at the corners of the display screen 20 to maintain registration with the previously printed electrode layer. The alignment marks enable precise positioning of the encapsulation printing screen relative to the electrode pattern deposited by the electrode printing screen of FIG. 3A. Proper registration between the electrode layer and the encapsulation layer ensures that the openings in the protective encapsulation layer 204 are aligned with the active electrode surfaces, exposing the functionalized electrodes while preventing fluid from reaching the printed traces.

The two display screens 20 work together in a sequential fabrication process. The electrode printing screen of FIG. 3A deposits the conductive pattern first, forming the conductive structures 202 that define the electrode pads, interconnect traces, and the reader interface 112 region. After the conductive ink is deposited and cured, the encapsulation printing screen of FIG. 3B deposits the protective encapsulation layer 204 over the traces while defining openings that expose the active electrode areas. The protective encapsulation layer 204 inhibits fluid ingress to the conductive structures 202 while exposing the active surfaces of the plurality of electrochemical electrodes, thereby preventing shorting of the printed traces when the sensor module 110a-n is immersed in a fluid sample.

The screen-printing fabrication process may enable cost-effective and scalable production of the sensor modules 110a-n. The solution-processed, print-based electrodes may be manufactured in parallel on each sensor module 110a-n, and other sensors may be integrated onto the substrate 200 using compatible printing or assembly techniques. The screen-printing approach may accommodate various substrate materials including FR-4, polyethylene naphthalate, polyethylene terephthalate, paper, and cellulose-based films, providing flexibility in sensor module 110a-n design for different mechanical, thermal, and environmental requirements.

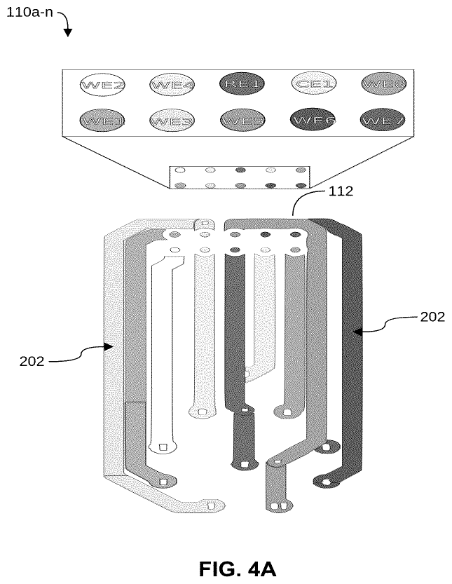

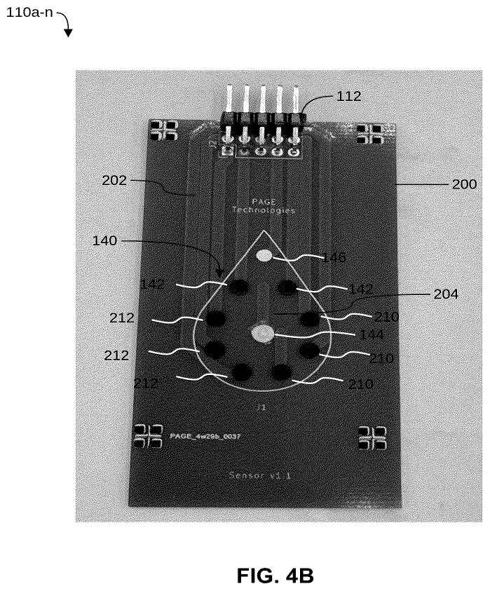

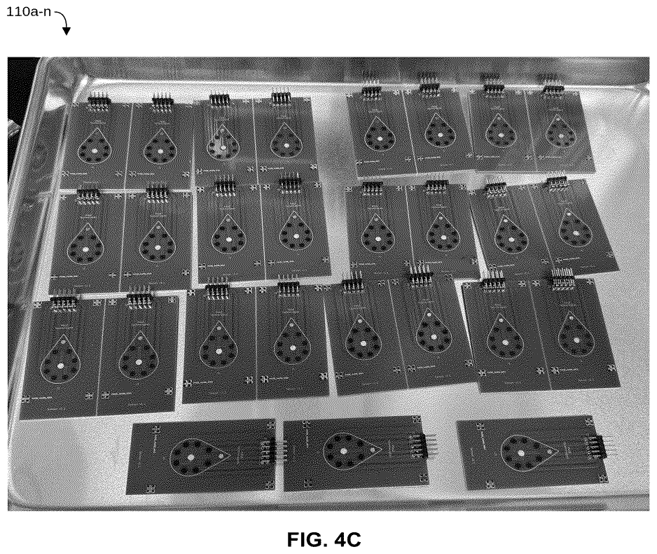

Referring now to FIG. 4A, an exploded view diagram of an exemplary printed sensor card 110a-n is described, showing the structural arrangement of electrode components according to aspects of the present disclosure. The reader interface region 112 can be configured with a plurality of labeled electrode contact pads arranged in two rows. The top row includes contact pads labeled WE2, WE4, RE1, CE1, and WE8, corresponding to working electrodes, a reference electrode, and a counter electrode, respectively. The bottom row includes contact pads labeled WE1, WE3, WE5, WE6, and WE7, corresponding to additional working electrodes. The reader interface region 112 is configured to releasably mate with electronic reader 120. Below the reader interface region 112, a connector region includes a series of through-holes positioned along its lower edge for establishing electrical connections between the contact pads and the individual electrode traces. The through-holes provide a mechanical and electrical pathway that couples the conductive contact pads of the reader interface region to the conductive structures that extend toward the sensing region of the sensor module. The through-hole configuration may enable robust electrical connectivity between the reader interface region and the electrode traces while accommodating different substrate thicknesses and fabrication approaches.

With continued reference to FIG. 4A, individual conductive structures 202 extend downward from the connector region. Each conductive structure 202 can comprises an elongated conductive trace, for example, terminating in a sensing region at its distal end. The conductive structures 202 are shown separated from one another to illustrate their individual configurations and spatial relationships within the assembled sensor card. The conductive structures vary in shading from light gray to dark gray, representing different electrode types including working electrodes, reference electrode, and counter electrode. The sensing regions at the distal ends of the conductive structures 202 include apertures and features configured to be exposed to a sample medium when the sensor module 110a-n is deployed. The exploded view illustrates the layered construction approach used in fabricating the printed sensor card, where individual electrode components are assembled onto a substrate to form a complete multi-electrode sensing array.

FIG. 4B illustrates a plan view of an exemplary sensor module 110a-n showing an example physical layout and electrode arrangement on substrate 200. The reader interface 112 comprises a header connector with multiple conductive pins configured to engage corresponding contacts of the electronic reader 120. Below the reader interface, several small electronic components are mounted on the substrate surface, and the conductive structures 202 extend downward from the reader interface 112 as parallel traces routing signals from the electrodes to the contact pins. A teardrop-shaped outline on the substrate 200, delineates a sensing region in the sensor module 110a-n. The reference electrode 144 can positioned at the center of the sensing region. The central placement of the reference electrode 144 reduces potential gradients among the surrounding working electrodes 142. Working electrodes 142 can be functionalized with ion-selective membranes configured to generate electrical responses to target analytes when exposed to a fluid or porous-media sample. Conductive structures 202 connect the electrodes to the reader interface 112. The protective encapsulation layer 204 overlies portions of the conductive structures 202 while defining openings that expose active surfaces of the electrochemical electrodes. Printed identification markings and version designations can be provided on the surface of the substrate 200.

FIG. 4C illustrates a group of various interchangeable sensor modules 110a. The arrangement of multiple sensor modules illustrates the batch manufacturing capability and the modular, replaceable nature of the sensor modules 110a-n, which are designed for tool-free insertion and removal from the electronic reader 120.

The substrate 200 may comprise FR-4, polyethylene naphthalate (PEN), polyethylene terephthalate (PET), paper, or a cellulose-based film. The substrate may also comprise balsa wood or wax-coated surfaces as sustainable and biodegradable materials. The sensor module 110a-n may use sustainable and biodegradable materials including paper, cellulose-based films, and eco-friendly composites to reduce environmental impact. The diverse substrate options provide versatility in sensor design, accommodating different mechanical, thermal, and environmental requirements while enabling selection of materials appropriate for the intended deployment environment and sustainability considerations of a particular application.

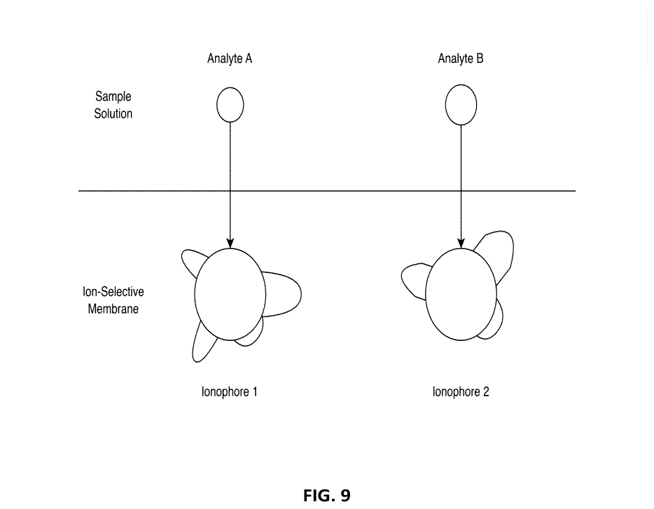

Referring now to FIG. 9, a schematic cross-sectional view of an ion-selective membrane architecture is described, illustrating a configuration in which multiple ionophores are embedded within a single ion-selective membrane to enable simultaneous detection of multiple analytes of a sample. As shown in FIG. 9, a sample solution containing two different analytes, labeled as Analyte A and Analyte B, is positioned above an ion-selective membrane. The ion-selective membrane contains two distinct ionophores, labeled as Ionophore 1 and Ionophore 2, each depicted as an irregular closed shape embedded within the membrane. Analyte A is shown with an arrow pointing toward Ionophore 1, indicating selective interaction between Analyte A and Ionophore 1. Similarly, Analyte B is shown with an arrow pointing toward Ionophore 2, indicating selective interaction between Analyte B and Ionophore 2. The arrangement illustrates how different ionophores embedded within a single ion-selective membrane may selectively bind to and detect different target analytes simultaneously, enabling multi-ion sensing capability within a single membrane structure.

As described previously, each ion-selective electrode of the first redundant group may comprise an ion-selective membrane including a polymeric matrix, a plasticizer, an ion exchanger, and one or more ionophores selected to interact selectively with the same target analyte. The ion-selective membrane may be formulated as an ion-selective membrane cocktail comprising the polymeric matrix, the plasticizer, the ion exchanger, one or more ionophores, and a solvent. The ion-selective membrane cocktail may also include a salt of the primary ion to pre-condition the electrodes prior to membrane deposition. After the solvent evaporates, the ion-selective membrane cocktail may form a polymeric matrix that is selective to the ion-of-interest.

The polymeric matrix of the ion-selective membrane may comprise polyvinyl chloride, carboxylated polyvinyl chloride, polyurethane, silicone rubber, polydimethylsiloxane, polymethyl methacrylate, polyacrylate, polyvinylidene fluoride, Nafion, poly(ethylene glycol) dimethacrylate, polystyrene-divinylbenzene, poly(2-hydroxyethyl methacrylate), polypyrrole, polysiloxane-based membranes, or fluorosilicone. In some cases, the polymeric matrix of the ion-selective membrane may comprise any of the above polymers doped with nanoparticles to modify membrane properties such as conductivity, mechanical strength, or selectivity.

The ion exchanger of the ion-selective membrane may comprise tetraphenylborate derivatives such as tetrakis(4-chlorophenyl) borate, tridodecylmethylammonium chloride, trioctylmethylammonium chloride, Aliquat 336, tetraoctylammonium bromide, dioctyl phthalate doped with ionophore salts, tetradodecylammonium tetrakis(4-chlorophenyl) borate, sodium tetraphenylborate, or bis(trifluoromethylsulfonyl)imide salts. The ion exchanger may facilitate charge transfer across the membrane interface and maintain electroneutrality within the ion-selective membrane.

The plasticizer of the ion-selective membrane may comprise dioctyl phthalate, bis(2-ethylhexyl) phthalate, dibutyl phthalate, dioctyl sebacate, diisononyl phthalate, trioctyl phosphate, tris(2-ethylhexyl) phosphate, bis(2-ethylhexyl) adipate, bis(2-ethylhexyl) sebacate, N-butylbenzenesulfonamide, o-nitrophenyloctyl ether, or tetraethylene glycol dimethyl ether. The plasticizer may impart flexibility to the polymeric matrix and may serve as a solvent medium for the ionophore within the membrane.

The solvent for the ion-selective membrane cocktail may comprise tetrahydrofuran, cyclohexanone, dimethylformamide, dimethyl sulfoxide, acetone, chloroform, methanol, ethanol, 1-methyl-2-pyrrolidone, dichloromethane, ethyl acetate, or 2-butanone. The solvent may dissolve the polymeric matrix, plasticizer, ion exchanger, and ionophore components to form a homogeneous cocktail that can be deposited onto the electrode surface.

The ion-selective membrane may be deposited by dropcasting, transfer printing, stamping, or polymerization on the electrode surface. In dropcasting, the ion-selective membrane cocktail may be dispensed directly onto the electrode surface and allowed to dry. In transfer printing, the ion-selective membrane cocktail may be deposited onto another surface and transferred to the electrodes. In stamping, a patterned stamp may transfer the membrane material to defined electrode locations. In polymerization, the membrane may be formed directly on the electrode surface through a chemical reaction. The ion-selective membrane may be UV or thermal cured to form the polymeric matrix depending on the backbone polymer selected for the formulation.

Each membrane may be formulated as an ‘ISM cocktail’ which may include a backbone polymer, various ion exchangers (also called ‘counter-ions’), various plasticizers and solvents (Table 1). These are included as examples only.

TABLE 1

| Category | Material |
|---|---|
| Polymers | Polyvinyl chloride (PVC) |
| | Carboxylated polyvinyl chloride (PVC-COOH) |
| | Polyurethane (PU) |
| | Silicone rubber |
| | Polydimethylsiloxane (PDMS) |
| | Polymethyl methacrylate (PMMA) |
| | Polyacrylate (PA) |
| | Polyvinylidene fluoride (PVDF) |
| | Nafion (Perfluorosulfonic acid polymer) |
| | Poly(ethylene glycol) dimethacrylate (PEGDMA) |
| | Polystyrene-divinylbenzene (PS-DVB) |
| | Poly(2-hydroxyethyl methacrylate) (PHEMA) |
| | Polypyrrole (PPy) |
| | Polysiloxane-based membranes |
| | Fluorosilicone (FS) |
| | Any above polymers doped with nanoparticles |
| Ion Exchangers | Tetraphenylborate derivatives |
| | (e.g., Tetrakis(4-chlorophenyl)borate, NaTPB) |
| | Tridodecylmethylammonium chloride (TDMAC) |
| | Trioctylmethylammonium chloride (TOMAC) |
| | Aliquat 336 (Methyltrioctylammonium chloride) |
| | Tetraoctylammonium bromide (TOAB) |
| | Dioctyl phthalate doped with ionophore salts |
| | Tetradodecylammonium tetrakis(4-chlorophenyl)borate |
| | Sodium tetraphenylborate (NaTPB) |
| | Bis(trifluoromethylsulfonyl)imide (TFSI) salts |
| Plasticizers | Dioctyl phthalate (DOP) |
| | Bis(2-ethylhexyl) phthalate (BEHP) |
| | Dibutyl phthalate (DBP) |
| | Dioctyl sebacate (DOS) |
| | Diisononyl phthalate (DINP) |
| | Trioctyl phosphate (TOP) |
| | Tris(2-ethylhexyl) phosphate (TEHP) |
| | Bis(2-ethylhexyl) adipate (DOA) |
| | Bis(2-ethylhexyl) sebacate (DOS) |
| | N-Butylbenzenesulfonamide (NBBS) |
| | o-Nitrophenyloctyl ether (o-NPOE) |
| | Tetraethylene glycol dimethyl ether (TEGDME) |
| Solvents | Tetrahydrofuran (THF) |
| | Cyclohexanone |
| | Dimethylformamide (DMF) |
| | Dimethyl sulfoxide (DMSO) |
| | Acetone |
| | Chloroform |
| | Methanol |
| | Ethanol |
| | 1-Methyl-2-pyrrolidone (NMP) |
| | Dichloromethane (DCM) |
| | Ethyl acetate |
| | 2-Butanone (Methyl ethyl ketone, MEK) |

Table 2 below indicates various ionophores that may be incorporated depending on the ion being measured with the particular electrode. These are included as examples only.

TABLE 2

| | Chemical | |
|---|---|---|
| Ion | Formula | Common Ionophore(s) |
| Nitrate | NO₃⁻ | α,α,α,α-5,10,15,20-Tetrakis{2-[3-(4- |
| | | methylphenyl)ureido]phenyl}porphyrine |
| Ammonium | NH₄⁺ | Nonactin, Monactin, Dinactin (Macrotetrolide |
| | | Ionophores) |
| Dihydrogen | H₂PO₄⁻ | Uranyl Salophene Complexes, Polymeric |
| Phosphate | | Quaternary Ammonium Salts |
| Hydrogen Phosphate | HPO₄²⁻ | Uranyl Salophene Complexes, Polymeric |
| | | Quaternary Ammonium Salts |
| Phosphate | PO₄³⁻ | Uranyl Salophene Complexes, Polymeric |
| | | Quaternary Ammonium Salts |
| Potassium | K⁺ | Valinomycin |
| Calcium | Ca²⁺ | ETH 1001 (N,N,N′,N′-Tetracyclohexyl-3- |
| | | oxapentanediamide) |
| Magnesium | Mg²⁺ | ETH 7025 (N,N′-Bis(salicylidene)-1,2- |
| | | phenylenediamine Complexes) |
| Sulfate | SO₄²⁻ | Quaternary Ammonium Salts (e.g., Aliquat 336, |
| | | Tetraalkylammonium Derivatives) |
| Ferrous Iron | Fe²⁺ | Bathophenanthroline, Phenanthroline Derivatives |
| Ferric Iron | Fe³⁺ | Bathophenanthroline, Phenanthroline Derivatives |
| Manganese | Mn²⁺ | Bis(salicylaldehyde)ethylenediamine Complexes |
| Zinc | Zn²⁺ | Di(2-ethylhexyl)phosphoric acid (D2EHPA), |
| | | Bis(pyridylmethyl)amine (BPMA) |
| Copper | Cu²⁺ | Bathocuproine, Neocuproine, Dithizone |
| Borate | BO₃³⁻ | Crown Ethers, Boron-Specific Fluorescent Dyes |
| | | (e.g., Alizarin Red S) |
| Tetrahydroxyborate | B(OH)₄⁻ | Crown Ethers, Boron-Specific Fluorescent Dyes |
| | | (e.g., Alizarin Red S) |
| Molybdate | MoO₄²⁻ | Dithiolene Ligands, Thiocyanate Complexes |
| Chloride | Cl⁻ | Quaternary Ammonium Salts (e.g., Aliquat 336, |
| | | Tetraphenylborate Complexes) |
| Sodium | Na⁺ | Bis(12-crown-4), Sodium Ionophore X |
| Carbonate | CO₃²⁻ | ETH 6010 (Heptyl 4-trifluoroacetylbenzoate), |
| | | ETH 6022 (1-(Dodecylsulfonyl)-4- |
| | | trifluoroacetylbenzene) |

The chemically selective membrane material may comprise one or more ion-selective membranes including ionophores configured to selectively respond to nitrate and potassium. The at least one ionophore may comprise valinomycin when the first target analyte is potassium. Valinomycin is a macrocyclic ionophore that selectively binds potassium ions through coordination within its cyclic structure. The at least one ionophore may comprise a porphyrin-based carrier when the first target analyte is nitrate. The porphyrin-based carrier for nitrate-selective electrodes may comprise porphyrine, which selectively interacts with nitrate ions through hydrogen bonding and electrostatic interactions.

With continued reference to FIG. 9, multiple ionophores may be within the ion-selective membrane to enable simultaneous detection of multiple analytes of the sample. By embedding multiple ionophores within a single ion-selective membrane, the sensors may be tuned to prioritize selectivity for individual ions or may be designed to exhibit cross-selectivity, allowing for the detection of ions with similar chemical properties. The cross-selectivity approach may be leveraged in machine-learning algorithms to improve measurement accuracy in complex media, where interfering species may otherwise degrade sensor performance. By analyzing sensor response patterns and training models on chemical and biological aqueous mixtures of known composition, machine-learning-enhanced calibration may dynamically adjust for ion interference, environmental variability, and drift.

In formulating multi-ionophore membranes for simultaneous detection of multiple analytes, the ionophores may be dissolved together with the polymeric matrix, plasticizer, ion exchanger, and solvent to form a homogeneous ion-selective membrane cocktail. Each ionophore retains its selective binding characteristics within the shared polymeric matrix, as the ionophores operate through independent molecular recognition mechanisms. For example, valinomycin selectively binds potassium ions through coordination chemistry within its macrocyclic structure, while porphyrin-based carriers interact with nitrate ions through hydrogen bonding and electrostatic interactions. Because these binding mechanisms are chemically distinct, the ionophores do not interfere with each other's selectivity when co-located within the same membrane. The relative concentrations of the ionophores may be adjusted to tune the response characteristics for each target analyte, with higher ionophore concentrations generally producing stronger responses to the corresponding analyte. The ion exchanger within the membrane maintains electroneutrality across the multiple ionophore-analyte interactions by providing mobile charged sites that balance the charge transfer associated with each ionophore-ion complex. In some cases, multiple ionophores selective to the same analyte may be combined within a single membrane to improve performance characteristics such as response range, selectivity, or stability. The multi-ionophore membrane cocktail may be deposited onto the electrode surface using the same deposition techniques employed for single-ionophore membranes, including dropcasting, transfer printing, stamping, or in situ polymerization, followed by solvent evaporation and optional UV or thermal curing to form the polymeric matrix.

The ionophore for ammonium-selective electrodes may comprise nonactin, monactin, or dinactin macrotetrolide ionophores. The ionophore for phosphate-selective electrodes may comprise uranyl salophene complexes or polymeric quaternary ammonium salts. The ionophore for calcium-selective electrodes may comprise ETH 1001, which is N,N,N′,N′-tetracyclohexyl-3-oxapentanediamide. The ionophore for magnesium-selective electrodes may comprise ETH 7025. The ionophore for sulfate-selective electrodes may comprise quaternary ammonium salts such as Aliquat 336 or tetraalkylammonium derivatives. The ionophore for iron-selective electrodes may comprise bathophenanthroline or phenanthroline derivatives. The ionophore for manganese-selective electrodes may comprise bis(salicylaldehyde)ethylenediamine complexes. The ionophore for zinc-selective electrodes may comprise di(2-ethylhexyl)phosphoric acid or bis(pyridylmethyl)amine. The ionophore for copper-selective electrodes may comprise bathocuproine, neocuproine, or dithizone. The ionophore for borate-selective electrodes may comprise crown ethers or boron-specific fluorescent dyes such as Alizarin Red S. The ionophore for molybdate-selective electrodes may comprise dithiolene ligands or thiocyanate complexes. The ionophore for chloride-selective electrodes may comprise quaternary ammonium salts such as Aliquat 336 or tetraphenylborate complexes. The ionophore for sodium-selective electrodes may comprise bis(12-crown-4) or Sodium Ionophore X. The ionophore for carbonate-selective electrodes may comprise ETH 6010 or ETH 6022.

A secondary hydrophobic layer may be deposited on top of the ion-selective membrane to prevent leaching of membrane components into the environment. The secondary hydrophobic layer may comprise silicone, polytetrafluoroethylene, or other hydrophobic polymers. The secondary hydrophobic layer may extend sensor longevity by retaining the ionophore, plasticizer, and ion exchanger within the membrane structure during prolonged exposure to aqueous samples.

At least one working electrode 142 of the sensor module 110a-n may further comprise an ion-to-electron transduction layer disposed between an underlying conductor and the chemically selective membrane material. The ion-to-electron transduction layer may improve electrode performance by facilitating charge transfer between the ionic species detected by the chemically selective membrane material and the electronic circuit of the underlying conductor. The ion-to-electron transduction layer may stabilize the potentiometric interface by providing a well-defined electrochemical pathway that reduces signal noise and drift associated with direct contact between the ion-selective membrane and the metallic conductor.

The ion-to-electron transduction layer may comprise a high-surface-area carbon material or a conductive polymer. High-surface-area carbon materials suitable for the ion-to-electron transduction layer may include carbon nanotubes, graphene, reduced graphene oxide, carbon black, mesoporous carbon, and other allotropes of carbon that provide a large electrochemically active surface area. The high-surface-area carbon materials may enhance the capacitive coupling between the ion-selective membrane and the underlying conductor, thereby improving signal stability and reducing potential drift over time.

The ion-to-electron transduction layer may comprise a conductive polymer such as poly(3,4-ethylenedioxythiophene) polystyrene sulfonate (PEDOT:PSS). PEDOT:PSS is a mixed ionic-electronic conductor that may facilitate ion-to-electron transduction through redox reactions at the polymer-membrane interface. Other conductive polymers suitable for the ion-to-electron transduction layer may include polypyrrole, polyaniline, and polythiophene derivatives. The conductive polymer may be doped or functionalized to tune its electrochemical properties for compatibility with specific ion-selective membrane formulations.

The ion-to-electron transduction layer may be deposited electrochemically or by printing on top of the conductive layer. In electrochemical deposition, the conductive polymer or carbon material may be deposited onto the underlying conductor through an electropolymerization process or electrophoretic deposition. In printing-based deposition, the ion-to-electron transduction layer may be deposited using screen printing, inkjet printing, or dropcasting of an ink or dispersion containing the high-surface-area carbon material or conductive polymer. The printing-based deposition approach may enable parallel fabrication of the ion-to-electron transduction layer across multiple electrodes on the sensor module, consistent with the scalable manufacturing approach described previously for the conductive structures and protective encapsulation layer. The ion-to-electron transduction layer may form a conformal, electronically conducting, ion-permeable interface that efficiently couples membrane ion activity changes to measurable electrode potential shifts. The ion-to-electron transduction layer may bridge the ionic domain of the chemically selective membrane material with the electronic domain of the underlying conductor, thereby providing a well-defined electrochemical pathway for signal transduction.

The sensor module 110a-n may incorporate organic electrochemical transistors with organic semiconducting polymers as channel materials for higher sensitivity detection. The organic electrochemical transistors may utilize the ion-to-electron transduction layer as part of the transistor channel, where changes in ionic concentration at the membrane interface modulate the conductivity of the organic semiconducting polymer channel. The transistor configuration may provide signal amplification through transconductance, enabling detection of analytes at lower concentrations than passive potentiometric electrodes may achieve. The organic electrochemical transistors may be configured for potentiometric, voltammetric, or amperometric interrogation depending on the measurement protocol selected by the electronic reader.

The sensor module 110a-n may be configured to detect a range of analytes beyond ionic nutrients. The sensor module may be configured to detect oxidation-reduction potential, heavy metals, contaminants, pollutants, pesticides, pathogens, biomolecules, metabolites, and fungicides using electrode architectures that incorporate the ion-to-electron transduction layer. For detection of heavy metals such as lead, cadmium, arsenic, and mercury, the working electrodes may be functionalized with chelating agents or ion-selective membranes that selectively bind the target metal ions. For detection of biomolecules, metabolites, and pathogens, the working electrodes may incorporate biorecognition elements such as enzymes, antibodies, aptamers, or nucleic acid probes that interact with the target analyte.

The sensor module 110a-n may incorporate molecularly imprinted polymer membranes for selective analyte detection. Molecularly imprinted polymers are synthetic polymers that contain recognition sites complementary in shape, size, and functional group arrangement to a target analyte molecule. The molecularly imprinted polymer membranes may be formed by polymerizing monomers in the presence of a template molecule, which is subsequently removed to leave behind cavities that selectively bind the target analyte. The molecularly imprinted polymer membranes may enable detection of analytes for which natural ionophores or biorecognition elements are unavailable or impractical.

The sensor module 110a-n may incorporate composite carbon-based electrodes functionalized with materials such as Alizarin for bulk sensing applications. Alizarin is a pH-sensitive dye that undergoes redox reactions at potentials that shift with proton activity, enabling voltammetric detection of pH. The composite carbon-based electrodes may comprise carbon ink or carbon paste mixed with Alizarin or other electroactive materials that provide sensitivity to target analytes. The composite carbon-based electrodes may be used for bulk electrochemical sensing where the analyte interacts with the electrode material throughout the electrode volume rather than at a surface membrane interface.

As described previously, for at least one of the target analytes, the plurality of working electrodes 142 may include a redundant group of two or more substantially similar electrodes of the working electrode 142 configured to generate respective electrical responses to the at least one of the target analytes. The redundant group architecture provides multiple independent measurements of the same analyte concentration, enabling statistical validation and improved measurement reliability compared to single-electrode configurations. Each electrode within the redundant group may be fabricated using the same materials, membrane formulations, and deposition processes, such that the electrodes exhibit substantially similar response characteristics to the target analyte under equivalent conditions.

The sensor module 110a-n may comprise a first redundant group of two or more substantially similar ion-selective electrodes of the working electrodes 142, each including chemically selective membrane material configured to generate an electrical response to a first target analyte when exposed to a fluid or porous-media sample. In some cases, the plurality of electrochemical electrodes 140 may further comprise a second redundant group of two or more substantially similar ion-selective electrodes of the working electrodes 142, each including chemically selective membrane material configured to generate an electrical response to a second target analyte different from the first target analyte. The first redundant group and the second redundant group may be disposed on the same substrate, enabling simultaneous monitoring of multiple target analytes with redundancy for each analyte type. For example, the first redundant group may comprise three nitrate-selective electrodes and the second redundant group may comprise three potassium-selective electrodes, as described previously with respect to the electrode arrangement on the sensor module.

The redundant group architecture may enable the data processing subsystem 130 to perform ensemble averaging across signals from the electrodes within each redundant group. Ensemble averaging may combine the individual electrode signals into a single representative value that reflects the consensus measurement of the redundant group. The ensemble average may reduce the influence of random noise present in individual electrode signals, thereby improving the precision of the corrected analyte values (also referred to as corrected outputs) compared to measurements derived from a single electrode.

Transforming the sensor data into the corrected analyte values may comprise performing ensemble averaging with outlier rejection across signals from working electrodes that report a same target analyte. Outlier rejection may identify and exclude electrode signals that deviate from the consensus of the redundant group by more than a predetermined threshold. The outlier rejection process may compare each electrode signal to the mean or median of the redundant group and may flag signals that exceed a specified deviation criterion as outliers. Signals identified as outliers may be excluded from the ensemble average computation, such that the corrected analyte value reflects the consensus of the remaining electrodes within the redundant group.

The electronic reader 120 and the data processing subsystem 130 may be configured to continue providing the corrected outputs when fewer than all electrodes of the redundant group remain within predetermined performance thresholds by excluding or down-weighting signals from electrodes that exceed the thresholds. The predetermined performance thresholds may define acceptable operating ranges for individual electrode signals based on metrics that characterize electrode health and measurement quality. When an electrode signal exceeds one or more of the predetermined performance thresholds, the data processing subsystem may reduce the weight assigned to that electrode signal in the ensemble computation or may exclude the electrode signal from the computation.

The predetermined performance thresholds may comprise at least one of a maximum permitted drift rate, a maximum calibration residual, a maximum impedance, a maximum noise level, a minimum signal-to-noise ratio, or a minimum inter-electrode agreement. The maximum permitted drift rate may define an upper limit on the rate at which an electrode signal changes over time in the absence of corresponding changes in analyte concentration. Electrodes exhibiting drift rates exceeding the maximum permitted drift rate may be flagged as degraded and may be excluded or down-weighted in the ensemble computation. The maximum calibration residual may define an upper limit on the deviation between an electrode signal and the expected signal based on calibration parameters. Electrodes exhibiting calibration residuals exceeding the maximum calibration residual may indicate membrane degradation or fouling that compromises measurement accuracy.

The maximum impedance threshold may define an upper limit on the electrical impedance of an electrode, where elevated impedance may indicate membrane delamination, loss of ionic contact, or other structural degradation. The maximum noise level threshold may define an upper limit on the signal variance or standard deviation observed over a measurement interval, where elevated noise may indicate electrical interference, membrane instability, or environmental disturbances. The minimum signal-to-noise ratio threshold may define a lower limit on the ratio of signal magnitude to noise magnitude, where low signal-to-noise ratios may indicate insufficient sensitivity or excessive interference that compromises measurement reliability.

The minimum inter-electrode agreement threshold may define a lower limit on the correlation or agreement between signals from electrodes within the same redundant group. Inter-electrode agreement may be quantified as the standard deviation, coefficient of variation, or range of signals within the redundant group. When inter-electrode agreement falls below the minimum threshold, the data processing subsystem may identify the electrode or electrodes that deviate from the group consensus and may exclude or down-weight those electrode signals. The inter-electrode agreement metric may enable detection of electrode-specific failures that would not be apparent from analysis of individual electrode signals in isolation.

The data processing subsystem 130 may assign quality scores to individual electrode signals based on the predetermined performance thresholds. The quality scores may reflect the degree to which each electrode signal satisfies the threshold criteria, with higher quality scores assigned to electrodes that exhibit low drift rates, low calibration residuals, low impedance, low noise levels, high signal-to-noise ratios, and high inter-electrode agreement. The quality scores may be used for selective weighting in the ensemble computation, where electrode signals with higher quality scores receive greater weight and electrode signals with lower quality scores receive reduced weight. The selective weighting approach may enable the data processing subsystem to continue providing corrected outputs that incorporate information from partially degraded electrodes while reducing the influence of those electrodes on the final result.

The redundant group architecture may extend the operational lifetime of the sensor module 110a-n by enabling continued operation when individual electrodes 142 within a redundant group degrade or fail. As long as at least one electrode within the redundant group remains within the predetermined performance thresholds, the data processing subsystem 130 may continue to compute corrected analyte values for the corresponding target analyte. The graceful degradation capability may reduce the frequency of sensor module 110a-n replacement and may provide advance warning of impending sensor module failure as the number of electrodes within threshold decreases over time.

The data processing subsystem 130 may generate alerts or notifications when the number of working electrodes 142 within a redundant group that remain within predetermined performance thresholds falls below a specified minimum. The alerts may inform users that sensor module replacement is recommended or that measurement reliability has decreased below acceptable levels. The alerts may be transmitted through the data output layer 138 via the open application programming interface or through the visualization interface, enabling timely response to sensor degradation conditions.

The plurality of electrochemical electrodes 140 may be conditioned prior to deployment in single-ion and mixed-ion calibration solutions for a predetermined period to equilibrate membranes and reduce initial drift. The conditioning process may pre-treat the chemically selective membrane material before the sensor module is deployed in a target monitoring environment. During conditioning, the ion-selective membranes may equilibrate with the conditioning solution, saturate ion-exchange sites within the membrane, and stabilize the electrochemical interface between the membrane and the underlying electrode structure. The conditioning process may reduce signal drift that would otherwise occur during initial exposure to a sample, thereby improving measurement accuracy from the onset of deployment.

In some examples, single-ion conditioning solutions may contain a known concentration of the primary ion to which the electrode is selective, such as potassium chloride for potassium-selective electrodes or sodium nitrate for nitrate-selective electrodes. The single-ion conditioning solutions may allow the ion-selective membrane to equilibrate with the target analyte species and saturate ion-exchange sites within the membrane prior to exposure to complex sample matrices. In some cases, mixed-ion calibration solutions may contain multiple ionic species at known concentrations, simulating the ionic composition of the intended deployment environment and enabling the membrane to equilibrate under conditions representative of field use. The mixed-ion calibration solutions may include common interferents such as potassium, sulfate, phosphate, and chloride at concentrations representative of agricultural nutrient solutions, soil pore water, or environmental water sources. Ionic strength adjusters may be added to conditioning and calibration solutions to maintain a consistent ionic environment and reduce activity coefficient variations that could otherwise introduce calibration errors. In some cases, the ion-selective membrane cocktail may include a salt of the primary ion to pre-condition the electrodes prior to membrane deposition, thereby reducing the equilibration time required during subsequent conditioning steps. The choice of conditioning and calibration solutions may depend on the sensor type, target analytes, and intended application, with customized solutions formulated to match the specific ionic matrix of a particular deployment environment such as hydroponic nutrient solutions, soil pore water extracts, or industrial process water compositions.

The sensor conditioning may be performed in single-ion solutions, mixed ionic buffers, or customized calibration solutions for a predetermined period ranging from 1 to 168 hours. Single-ion solutions may contain a known concentration of the primary ion to which the electrode is selective, allowing the ion-selective membrane to equilibrate with the target analyte species. Mixed ionic buffers may contain multiple ionic species at known concentrations, simulating the ionic composition of the intended deployment environment and enabling the membrane to equilibrate under conditions representative of field use. Customized calibration solutions may be formulated to match the specific ionic matrix of a particular application, such as hydroponic nutrient solutions, soil pore water extracts, or industrial process water compositions.

The duration of the conditioning period may be selected based on the membrane formulation, the target analyte, and the intended application. Shorter conditioning periods of 1 to 24 hours may be sufficient for membranes with rapid equilibration kinetics or for applications where initial drift tolerance is acceptable. Longer conditioning periods of 24 to 168 hours may be employed for membranes that require extended equilibration to achieve stable response characteristics or for applications that demand high measurement accuracy from the first deployment.

The data processing subsystem 130 stores calibration parameters derived from the conditioning. The calibration parameters may include response slopes, intercepts, selectivity coefficients, and drift correction factors that characterize the electrochemical response of each electrode following conditioning. The calibration parameters may be stored in the memory of the data processing subsystem and may be applied by the calibration instructions to transform raw sensor signals into corrected analyte values during subsequent monitoring operations.

The sensor calibration process may follow an iterative step-up approach utilizing mixed electrolyte salt solutions, fertilizer solutions, buffer solutions, and ionic strength adjusters to establish accurate response curves for different analytes. In the iterative step-up approach, the sensor module 110a-n may be exposed to a series of calibration solutions with progressively increasing analyte concentrations. At each concentration step, the electrochemical response of each electrode may be recorded and compared to the known analyte concentration to derive calibration parameters. The iterative step-up approach may enable characterization of the electrode response across the full dynamic range of analyte concentrations expected in the target monitoring environment.

Mixed electrolyte salt solutions may contain multiple ionic species at defined concentrations, enabling calibration under conditions that simulate the ionic complexity of real-world samples. Fertilizer solutions may be used as calibration standards for agricultural monitoring applications, providing calibration data that reflects the specific ionic compositions encountered in hydroponic systems, soil amendments, and irrigation water. Buffer solutions may be used to calibrate pH-sensitive electrodes and to maintain stable pH conditions during calibration of ion-selective electrodes that exhibit pH-dependent response characteristics. Ionic strength adjusters may be added to calibration solutions to maintain a consistent ionic environment and reduce activity coefficient variations that could otherwise introduce calibration errors.

The sensor calibration may be performed across various electrical conductivity, pH, and temperature ranges to ensure precise measurements tailored to specific environmental conditions in which the sensor module will be deployed. Calibration across multiple electrical conductivity levels may account for the influence of ionic strength on electrode response and may enable accurate measurements in samples ranging from low-conductivity deionized water to high-conductivity agricultural runoff or industrial process water. Calibration across multiple pH levels may account for pH-dependent selectivity variations in ion-selective membranes and may enable accurate measurements in samples with pH values spanning the range encountered in the target application. Calibration across multiple temperature levels may account for temperature-dependent changes in electrode response, membrane permeability, and ionic activity coefficients, enabling accurate measurements under the thermal conditions expected during field deployment.

Real-time dosing experiments may be conducted to validate quasi real-time monitoring and ensure sensors dynamically respond to changing analyte concentrations. In real-time dosing experiments, known quantities of analyte may be added to a test solution while the sensor module continuously monitors the solution composition. The sensor response may be compared to the expected concentration change to verify that the sensor accurately tracks dynamic analyte variations with acceptable response time and accuracy. Real-time dosing experiments may validate that the sensor module and the data processing subsystem 130 together provide corrected analyte values that reflect actual concentration changes in the monitored environment. The data processing subsystem 130 can be configured to output the corrected values for any user or operator.

The calibration parameters derived from conditioning and calibration may be updated periodically based on field performance data. The data processing subsystem 130 may compare sensor readings to reference measurements or to expected values based on process knowledge, and may adjust calibration parameters to compensate for long-term drift or changes in sensor response characteristics. The trained machine-learning model implemented by the data processing subsystem may incorporate calibration parameter updates into its compensation algorithms, enabling continuous refinement of measurement accuracy over the operational lifetime of the sensor module.

The electronic reader 120 may interrogate the plurality of electrochemical electrodes 140 using one or more electrochemical measurement modalities to acquire raw sensor data. The one or more electrochemical measurement modalities may be selected from potentiometry, voltammetry, impedimetry, and amperometry to acquire the sensor data. Different electrode types disposed on the sensor module 110a-n may be interrogated with different modalities depending on the electrode structure and the target analyte or parameter being measured.

Potentiometry may be employed for interrogating ion-selective electrodes of the working electrodes 142. In potentiometric measurement, the electronic reader 120 may record the open-circuit voltage between an ion-selective electrode and the reference electrode 144 without applying an external current. The open-circuit voltage may reflect the phase-boundary potential at the ion-selective membrane interface, which varies with the activity of the target ion in the sample according to the Nernst equation. The potentiometric modality may be suitable for ion-selective electrodes functionalized with chemically selective membrane material including ionophores configured to selectively respond to target analytes such as nitrate, potassium, ammonium, calcium, and other ionic species.

Voltammetry may be employed for interrogating pH-sensitive electrodes 148 and other electrodes that incorporate electroactive materials. In voltammetric measurement, the electronic reader 120 may apply a controlled potential waveform between a working electrode and the reference electrode 144 while recording the resulting current. The potential waveform may comprise a linear sweep, a cyclic sweep, a square wave, or a differential pulse pattern depending on the measurement protocol selected. For pH-sensitive 148 electrodes incorporating pH-sensitive dyes such as Alizarin, the voltammetric response may exhibit current peaks at potentials that shift with proton activity, enabling determination of pH from the peak position or peak current magnitude. The counter electrode 146 may complete the three-electrode circuit for voltammetric interrogation, enabling current to flow between the working electrode and the counter electrode 146 while maintaining a stable potential at the reference electrode 144.

Impedimetry may be employed for interrogating the electrical conductivity sensors 162. In impedimetric measurement, the electronic reader 120 may apply an alternating current excitation signal to a pair of spaced electrodes and may record the complex impedance or solution resistance between the electrodes. The impedance response may reflect the ionic conductivity of the sample medium, which correlates with the total ionic strength and dissolved salt concentration. The electrical conductivity sensors 162 may comprise interdigitated electrode patterns or parallel electrode pairs configured for impedimetric interrogation. The impedimetric modality may also be employed for characterizing electrode health by measuring the impedance of ion-selective electrodes 142, where elevated impedance may indicate membrane degradation or loss of ionic contact.

Amperometry may be employed for interrogating electrodes configured for current-based detection of electroactive analytes. In amperometric measurement, the electronic reader 120 may apply a fixed potential between a working electrode and the reference electrode 144 while recording the resulting current over time. The current magnitude may reflect the concentration of an electroactive species undergoing oxidation or reduction at the electrode surface. The amperometric modality may be suitable for detection of analytes that undergo direct electron transfer at the electrode surface or for enzymatic sensors where an enzyme catalyzes a reaction that produces or consumes an electroactive species.

At least one of the plurality of working electrodes 142 may comprise an electrochemical transistor configured for potentiometric, voltammetric, or amperometric interrogation. The electrochemical transistor may comprise an organic electrochemical transistor with an organic semiconducting polymer as the channel material. In the transistor configuration, changes in ionic concentration at the membrane interface may modulate the conductivity of the organic semiconducting polymer channel, providing signal amplification through transconductance. The electrochemical transistor may be interrogated using potentiometric protocols where the gate potential is monitored at open circuit, voltammetric protocols where the gate potential is swept while monitoring channel current, or amperometric protocols where a fixed gate potential is applied while monitoring channel current over time. The transistor architecture may enable detection of analytes at lower concentrations than passive potentiometric electrodes may achieve due to the gain mechanism provided by the transistor structure.

The electronic reader 120 may select the appropriate electrochemical measurement modality for each electrode based on the electrode type and the measurement protocol stored in the microcontroller 127 or received from the data processing subsystem 130. The measurement circuitry of the electronic reader 120 may include signal conditioning components and an analog-to-digital converter configured to acquire signals across the different modalities. The electronic reader 120 may execute potentiometric, voltammetric, impedimetric, and amperometric measurement protocols sequentially or in parallel across different electrode channels, enabling comprehensive characterization of chemical analytes and physical parameters from a single sensor module 110a-n during a measurement cycle.

The method for monitoring chemical analytes and physical parameters in fluid or porous-media may further comprise exchanging the interchangeable sensor module for another interchangeable sensor module in accordance with a replacement schedule. The replacement schedule may define the interval at which each type of sensor module is replaced based on the expected degradation rate of the electrochemical sensing electrodes and other sensing components disposed on the sensor module. Different sensor modules may follow different replacement schedules depending on the analytes and parameters being monitored and the corresponding degradation characteristics of the chemically selective membrane materials and electrode structures.

The replacement schedule may replace a nutrient-sensing module more frequently than a module that senses pH, electrical conductivity, or temperature. Nutrient-sensing modules configured to monitor ionic species such as nitrate, ammonium, phosphate, and potassium may exhibit faster degradation of the ion-selective membranes due to leaching of ionophores, plasticizers, and ion exchangers from the polymeric matrix during prolonged exposure to aqueous samples. The chemically selective membrane material of nutrient-sensing electrodes may experience gradual loss of selectivity and sensitivity over time as membrane components diffuse into the surrounding medium, resulting in increased drift and reduced measurement accuracy.

The sensor module 110a-n may be designed for biweekly to bimonthly replacement for nutrient-sensing cards. The biweekly to bimonthly replacement interval for nutrient-sensing modules may balance measurement accuracy requirements against the cost and labor associated with sensor module replacement. More frequent replacement of nutrient-sensing modules may maintain measurement accuracy within acceptable thresholds by ensuring that the ion-selective membranes remain within their operational performance window throughout the deployment period.

In contrast, modules 110a-n configured to sense pH, electrical conductivity, or temperature may function for a full annual cycle before replacement. The pH-sensitive electrodes, electrical conductivity sensors, and temperature sensors may exhibit slower degradation rates compared to nutrient-sensing electrodes due to differences in the sensing mechanisms and materials employed. The pH-sensitive electrodes may incorporate composite materials or glass-based sensing elements that maintain stable response characteristics over extended periods. The electrical conductivity sensors may comprise metallic or carbon-based electrode pairs that do not rely on chemically selective membranes and may therefore exhibit reduced susceptibility to membrane-related degradation mechanisms. The temperature sensors may comprise solid-state sensing elements such as thermistors or resistance temperature detectors that maintain stable calibration over annual deployment cycles.

The differentiated replacement schedule may enable cost-effective maintenance of the modular electrochemical sensing system 100 while preserving data quality across all monitored parameters. By replacing nutrient-sensing modules at shorter intervals while retaining pH, electrical conductivity, and temperature sensing modules for longer periods, users may minimize the total cost of consumable sensor modules while maintaining measurement accuracy for each parameter type. The modular architecture of the sensing system may facilitate the differentiated replacement approach by enabling independent exchange of individual sensor modules without requiring replacement of the entire sensing array.

The replacement schedule may be customized based on the specific deployment environment and monitoring requirements of a particular application. In applications where nutrient concentrations are monitored in aggressive media with high ionic strength or elevated temperatures, the replacement interval for nutrient-sensing modules may be shortened to account for accelerated membrane degradation. In applications where nutrient concentrations are monitored in benign media with low ionic strength and moderate temperatures, the replacement interval for nutrient-sensing modules may be extended while still maintaining acceptable measurement accuracy.

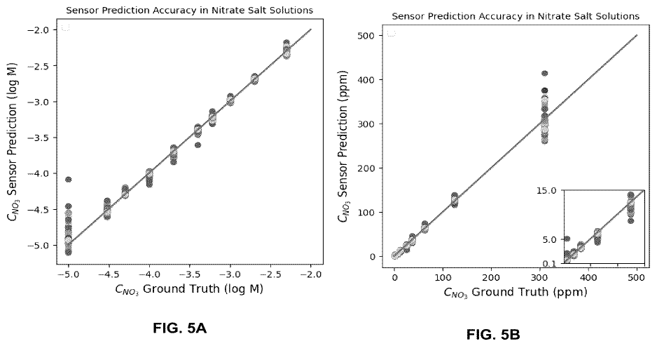

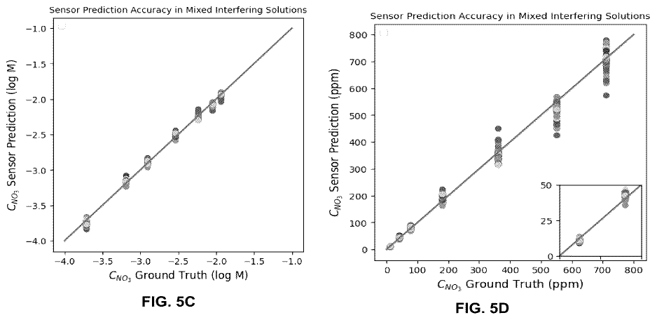

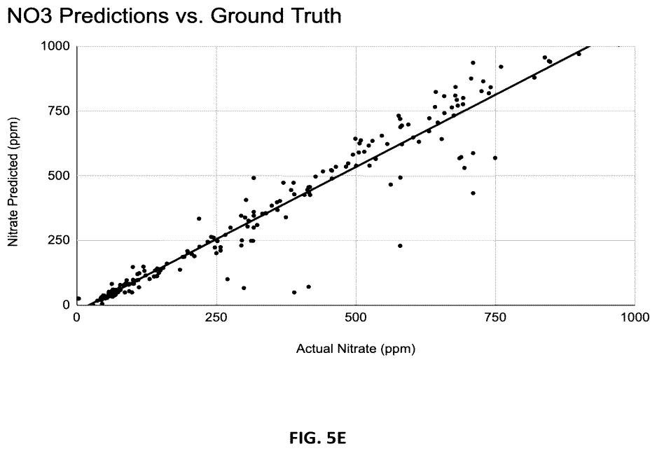

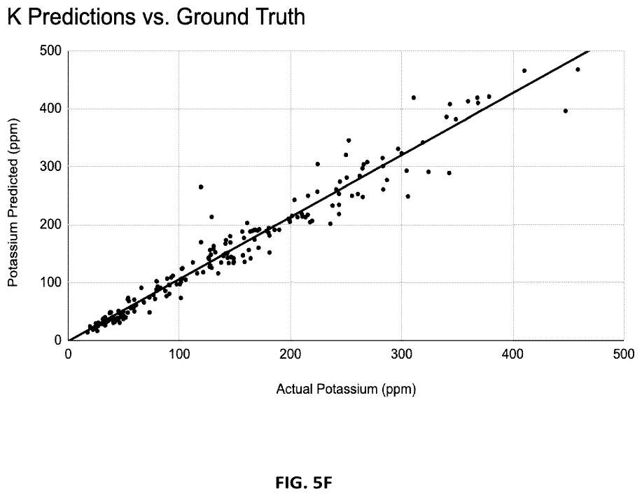

Referring now to FIGS. 5A-5B, sensor performance validation data is described for nitrate sensor predictions in simple salt solutions. FIGS. 5A-5B depict two scatter plot charts showing sensor prediction accuracy in nitrate salt solutions containing deionized water spiked with nitrate salts. The left chart of FIGS. 5A-5B displays data on a logarithmic scale with the x-axis representing ground truth nitrate concentration in log molar units and the y-axis representing sensor prediction in log molar units. A diagonal reference line extends from the lower left to the upper right corner representing perfect prediction accuracy where predicted values equal ground truth values. Data points cluster along this diagonal line, indicating strong correlation between ground truth values and sensor predictions across the logarithmic concentration range. The right chart of FIGS. 5A-5B displays the same type of data on a linear scale with the x-axis representing ground truth nitrate concentration in parts per million and the y-axis representing sensor prediction in parts per million. Data points follow the diagonal line closely in the lower concentration ranges and show some scatter at higher concentrations. An inset within the right chart provides an expanded view of the low concentration region, showing data points at concentrations below approximately fifteen parts per million with finer resolution.

With continued reference to FIGS. 5A-5B, the validation data comprises 60 measurements at each concentration point, derived from 10 sensor arrays with six nitrate sensors per array. The redundant electrode architecture enables statistical validation of sensor performance across the concentration range tested. The distribution of data points along the diagonal reference line demonstrates that the printed nitrate sensors generate predictions that correlate with ground truth concentrations across multiple orders of magnitude in simple salt solutions.

FIGS. 5C-5D depict two scatter plot charts showing sensor prediction accuracy in mixed interfering solutions containing multiple analytes commonly found in agricultural and environmental water sources, including potassium, sulfur, phosphate, and chloride. The left chart of FIGS. 5C-5D displays nitrate concentration sensor prediction on a logarithmic scale, with the x-axis representing ground truth nitrate concentration in log molar units and the y-axis representing sensor prediction in log molar units. Data points cluster along the diagonal line representing perfect accuracy, indicating strong correlation between sensor predictions and actual concentrations across the tested range in the presence of interfering species. The right chart of FIGS. 5C-5D displays the same nitrate sensor prediction data on a linear parts-per-million scale. Data points follow the diagonal line closely throughout the concentration range, with an inset graph providing an expanded view of the lower concentration region from zero to approximately fifty parts per million on both axes.

As further shown in FIGS. 5C-5D, the validation data in mixed interfering solutions also comprises 60 measurements at each concentration point from the redundant electrode arrays. The data demonstrates that the printed nitrate sensors maintain accuracy when tested in solutions containing multiple interfering species, validating the selectivity of the chemically selective membrane material in complex media representative of real-world agricultural and environmental monitoring conditions.

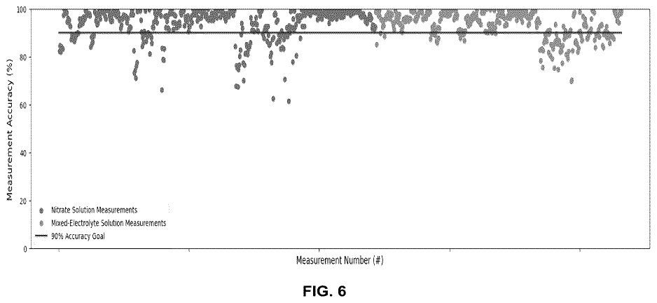

FIG. 6 depicts a scatter plot chart showing measurement accuracy as a percentage on the vertical axis versus measurement number on the horizontal axis. A horizontal solid line is drawn across the chart at the 90 percent accuracy level, representing a 90% accuracy goal. Two data series are plotted on the chart: nitrate solution measurements and mixed-electrolyte solution measurements. The data points for both series are predominantly clustered in the region between approximately 80 and 100 percent accuracy, with the majority of measurements appearing at or above the 90 percent accuracy goal line. Some data points fall below the 90 percent threshold, extending down to approximately 60 percent accuracy in certain instances.

With continued reference to FIG. 6, the accuracy data demonstrates that the sensors meet the 90 percent accuracy target across typical concentration ranges. The accuracy may drop below the 90 percent target at very low concentrations below approximately 1 part per million and at very high concentrations above approximately 500 parts per million. The distribution of accuracy values across both nitrate solution measurements and mixed-electrolyte solution measurements indicates that the sensor performance is maintained in the presence of interfering species across the concentration ranges encountered in agricultural and environmental monitoring applications.

FIG. 5E depicts a scatter plot chart comparing nitrate sensor predictions against ground truth measurements for nitrate concentration in parts per million, with data collected from field samples of unfiltered growing and environmental media. The horizontal axis represents actual nitrate concentration in parts per million, ranging from zero to one thousand. The vertical axis represents nitrate predicted concentration in parts per million, also ranging from zero to one thousand. A diagonal line extends from the origin to the upper right corner of the chart, representing a one-to-one correspondence between predicted and actual values. The data points are distributed along and around this diagonal line, with the majority of points clustering near the line throughout the concentration range. The field-collected samples originated from various hydroponic systems, aquaponic systems, and environmental water sources, with spectroscopic laboratory results serving as ground truth reference values. The collection comprises over 200 nitrate sensor measurements made in unfiltered growing and environmental media compared to values reported from third-party spectroscopic laboratories.

FIG. 5F depicts a scatter plot chart showing potassium predictions versus ground truth measurements. The vertical axis is labeled potassium predicted in parts per million and ranges from 0 to 500 parts per million. The horizontal axis is labeled actual potassium in parts per million and also ranges from 0 to 500 parts per million. A diagonal line extends from the origin toward the upper right corner, representing a line of perfect accuracy where predicted values would exactly equal actual values. Data points are distributed across the chart, with the majority of points clustered along or near the diagonal line, indicating a strong correlation between predicted and actual potassium concentrations. The data points show tighter clustering at lower concentrations and slightly more scatter at higher concentrations, particularly in the range between approximately 250 and 500 parts per million on the actual potassium axis. The chart demonstrates the accuracy of potassium sensor measurements made in unfiltered growing and environmental media compared to values reported from third-party spectroscopic laboratories. The collection comprises over 200 potassium sensor measurements from field-collected samples originating from various hydroponic systems, aquaponic systems, and environmental water sources.

The validation data presented in FIGS. 5A-5F demonstrates that the printed electrochemical sensors generate accurate predictions across concentration ranges encountered in agricultural and environmental monitoring applications. The redundant electrode architecture enables statistical validation through multiple measurements at each concentration point, and the ensemble averaging with outlier rejection performed by the data processing subsystem may further improve measurement reliability by combining signals from the redundant electrodes. The field validation data in FIGS. 5E-5F confirms that sensor accuracy is maintained when measuring unfiltered samples from real-world growing and environmental media, validating the applicability of the sensing system for practical deployment scenarios.

Referring now to FIGS. 10A-10C, a handheld portable probe 10 embodiment of the electronic reader 120 is described. FIG. 10A illustrates a perspective view of the handheld portable probe 10 being held by a user in an operational environment. The handheld portable probe 10 is shown positioned in front of a computer monitor displaying monitoring or control software. The handheld portable probe 10 includes a housing with a display screen 20 visible on a front surface of the housing, enabling real-time visualization of sensor data or measurements during portable spot-checking operations.

With continued reference to FIG. 10A, the handheld portable probe 10 comprises a compact form factor configured for portable deployment scenarios where users require immediate access to measurement data without fixed installation infrastructure. The handheld portable probe 10 may be carried by a user to various locations within a growing facility, field environment, or industrial site to obtain on-the-go nutrient and water quality measurements. The compact form factor of the handheld portable probe 10 may enable single-handed operation while viewing measurement results on the display screen 20.

The handheld portable probe 10 is configured to interface with the interchangeable sensor modules 110a-n for detecting chemical analytes and physical parameters in fluid or porous-media samples. The handheld portable probe 10 may include the module interface 122 configured to removably connect with the sensor modules 110a-n, enabling tool-free insertion and removal of the sensor modules 110a-n during field operations. The module interface 122 of the handheld portable probe 10 may comprise spring-loaded contacts, conductive pads, or a flexible connector that engages the reader interface 112 of the sensor module 110a-n when the sensor module 110a-n is inserted into the handheld portable probe 10.

As further shown in FIG. 10A, the handheld portable probe 10 may include the microcontroller 127 for real-time signal processing and the local storage 128 for data buffering when wireless connectivity is unavailable. The handheld portable probe 10 may include the wireless communication interface 124 configured to transmit data to the data processing subsystem 130 via Wifi, Bluetooth, LoRaWAN, cellular, or satellite protocols. The handheld portable probe 10 may include the power module 125 with a battery for portable operation without external power connections.

The display screen 20 of the handheld portable probe 10 may present corrected analyte values, raw sensor readings, system status indicators, and alert notifications to the user during spot-checking operations. The display screen 20 may comprise a touchscreen display that enables user interaction with the sensing system 100 through touch-based input. In some cases, the display screen 20 may comprise a non-touchscreen display with physical buttons embedded in the housing of the handheld portable probe 10 for user input.

The handheld portable probe 10 may support rapid assessment of nutrient concentrations, pH, electrical conductivity, and temperature in hydroponic systems, soil pore water, irrigation water, and environmental water sources. A user may contact the sensor module 110a-n with a sample of fluid or porous-media, and the handheld portable probe 10 may interrogate the electrochemical sensing electrodes 140 including the working electrodes 142 and the reference electrode 144 to acquire raw sensor data. The handheld portable probe 10 may transmit the sensor data to the data processing subsystem 130 for transformation into corrected analyte values, or may perform local processing using calibration parameters stored in the local storage 128.

The handheld portable probe 10 configuration of the electronic reader 120 may complement fixed installation deployments by enabling spot-checking measurements at locations where continuous monitoring infrastructure is not installed. Users may employ the handheld portable probe 10 to verify readings from fixed sensor installations, to assess conditions at remote locations within a facility or field, or to perform initial site assessments before deploying continuous monitoring systems. The portable configuration may reduce the infrastructure investment associated with comprehensive monitoring coverage while providing access to real-time measurement data across distributed locations.

The sensing system 100 operates through coordinated interaction among the sensor module 110a-n, the electronic reader 120, and the data processing subsystem 130 to perform continuous or discrete monitoring of chemical analytes and physical parameters in fluid or porous-media samples. The operational flow begins when the sensor module 110a-n is contacted with a sample of the fluid or porous-media, exposing the plurality of electrochemical electrodes 140 to the sample environment. The chemically selective membrane material disposed on the working electrodes 142 interacts with target analytes present in the sample, generating electrical responses that encode information about analyte concentrations and activities at the membrane-sample interface.

Upon contact with the sample, the electronic reader 120 interrogates the plurality of electrochemical electrodes 140 with respect to the reference electrode 144 to acquire raw sensor data. The measurement circuitry of the electronic reader 120 applies the appropriate electrochemical measurement modality to each electrode channel based on the electrode type and the measurement protocol stored in the microcontroller 127. For ion-selective electrodes of the working electrodes 142, the electronic reader 120 may record open-circuit potentials relative to the reference electrode 144 using potentiometric interrogation. For pH-sensitive 148 electrodes, the electronic reader 120 may apply voltammetric protocols that sweep the potential while recording current through the counter electrode 146. For the electrical conductivity sensors 162, the electronic reader 120 may apply impedimetric protocols that measure solution resistance or complex impedance between electrode pairs.

The signal conditioning circuitry of the electronic reader 120 processes the raw analog signals from the electrochemical sensing electrodes 140 prior to digitization. The transimpedance amplifier, programmable gain amplifier, and anti-aliasing filter condition the signals to reduce noise and prepare the signals for conversion by the analog-to-digital converter. The microcontroller 127 receives the digitized signals and may perform initial processing operations such as signal averaging, baseline correction, and data formatting before transmission to the data processing subsystem 130.

The electronic reader 120 transmits data representing the acquired signals to the data processing subsystem 130 via the wireless communication interface 124. The wireless communication interface 124 may transmit the data using WiFi, Bluetooth, LoRaWAN, cellular, or satellite protocols depending on the connectivity available at the deployment location and the configuration of the sensing system 100. In some cases, the electronic reader 120 may store data in the local storage 128 when wireless connectivity is temporarily unavailable, and may transmit the buffered data when connectivity is restored. In some cases, the electronic reader 120 may perform edge computing operations to pre-transform raw sensor data into physical parameter values prior to transmission, reducing the data volume transmitted to the data processing subsystem 130.

The data processing subsystem 130 receives the sensor data through the data ingestion layer 135, which handles real-time data ingestion and securely transfers readings to downstream processing and storage components. The data ingestion layer 135 may receive data from multiple electronic readers 120 deployed across a facility or field environment, aggregating sensor data from distributed sensor nodes into a centralized processing pipeline. The data storage layer 136 retains raw and processed sensor data along with associated metadata, enabling historical analysis, trend detection, and retrieval of past measurements for comparison with current readings.

The data processing and analytics 137 layer of the data processing subsystem 130 transforms the sensor data into corrected analyte values by applying a trained calibration model configured to compensate for one or more of sensor drift, environmental variability, and cross-ion interference. The trained calibration model may comprise a trained machine-learning model that has been trained on mixtures of known composition to learn the relationships between raw sensor signals and true analyte concentrations under varying environmental conditions. The trained machine-learning model may dynamically adjust calibration parameters to compensate for sensor degradation, temperature variations, ionic strength changes, and interference from non-target species present in the sample.

The trained calibration model may perform ensemble averaging with outlier rejection across signals from working electrodes 142 that report a same target analyte. The ensemble averaging combines individual electrode signals from a redundant group into a single representative value that reflects the consensus measurement of the group. The outlier rejection identifies and excludes electrode signals that deviate from the consensus by more than predetermined thresholds, preventing degraded or malfunctioning electrodes from corrupting the corrected analyte values. The trained calibration model may assign quality scores to individual electrode signals based on metrics such as drift rate, noise level, and inter-electrode agreement, and may apply selective weighting in the ensemble computation based on the quality scores.

The data processing subsystem 130 outputs the corrected analyte values for real-time monitoring through the data output layer 138. The data output layer 138 may expose the corrected analyte values through an open application programming interface for machine-to-machine integration with external control systems. The open application programming interface may support industrial protocols including BACnet and Modbus, enabling the corrected analyte values to flow into automated nutrient dosing systems, irrigation controllers, precision agriculture platforms, and other data-driven decision-making systems. External control systems may query the application programming interface to retrieve current analyte values and may use the values to adjust process parameters in closed-loop control configurations.

The data output layer 138 may provide event notifications upon detection of out-of-range conditions. When the corrected analyte values exceed or fall below predetermined thresholds, the data processing subsystem 130 may generate alerts that are transmitted to users via email, text message, or push notification, or may be transmitted to external control systems via the open application programming interface. The event notifications may enable timely response to conditions that require intervention, such as nutrient deficiencies, pH excursions, elevated contaminant levels, or sensor malfunctions.

The data output layer 138 may connect to a visualization interface that presents the corrected analyte values to users through a web-based dashboard. The web-based dashboard may display current sensor readings, historical trends, alert status, and system health indicators. Users may access the web-based dashboard from desktop computers, tablets, or mobile devices to monitor conditions and review data from remote locations. The visualization interface may present the corrected analyte values in graphical formats such as time-series charts, bar graphs, and spatial maps that facilitate interpretation of monitoring data and identification of patterns or anomalies.

The operational flow of the sensing system 100 may operate continuously for in-situ monitoring applications or may operate on a scheduled or on-demand basis for periodic measurement applications. In continuous monitoring configurations, the electronic reader 120 may interrogate the electrochemical sensing electrodes 140 at regular intervals, such as every minute, every five minutes, or every hour, and may transmit updated sensor data to the data processing subsystem 130 after each measurement cycle. The data processing subsystem 130 may update the corrected analyte values and refresh the visualization interface and application programming interface outputs in real time as new data is received.

In periodic or on-demand measurement configurations, the electronic reader 120 may remain in a low-power standby state between measurement events to conserve battery power for extended autonomous operation. The electronic reader 120 may wake from standby in response to a scheduled timer, a user command received through the wireless communication interface 124, or a trigger signal from an external system. Upon waking, the electronic reader 120 may interrogate the electrochemical sensing electrodes 140, transmit the sensor data to the data processing subsystem 130, and return to standby until the next measurement event.

The interaction among the sensor module 110a-n, the electronic reader 120, and the data processing subsystem 130 may be configured to support multiple sensor modules 110a-n deployed at different locations within a monitoring environment. Each electronic reader 120 may interface with one or more sensor modules 110a-n and may transmit sensor data from the connected sensor modules 110a-n to the data processing subsystem 130. The data processing subsystem 130 may aggregate data from multiple electronic readers 120 and may apply the trained calibration model to generate corrected analyte values for each sensor location. The visualization interface may present a unified view of monitoring data across all sensor locations, enabling users to compare conditions at different points within a facility, field, or watershed.

The sensing system 100 may support integration with external data sources to enhance the accuracy and context of the corrected analyte values. The data processing subsystem 130 may receive data from weather stations, soil moisture sensors, flow meters, and other environmental monitoring systems through the data ingestion layer 135. The trained calibration model may incorporate the external data into its compensation algorithms, using environmental context to improve the accuracy of analyte concentration estimates. For example, temperature data from an external weather station may be used to apply temperature compensation to ion-selective electrode readings, and flow rate data from a flow meter may be used to account for dilution effects in recirculating hydroponic systems.

The operational flow of the sensing system 100 may include automated calibration verification and recalibration procedures. The data processing subsystem 130 may periodically compare sensor readings to expected values based on process knowledge, historical patterns, or reference measurements from external sources. When deviations between sensor readings and expected values exceed predetermined thresholds, the data processing subsystem 130 may flag the sensor module 110a-n for recalibration or replacement. In some cases, the data processing subsystem 130 may automatically adjust calibration parameters based on the observed deviations, enabling continuous refinement of measurement accuracy without manual intervention.

Machine readable storage including machine-readable instructions, when executed, to implement a method or realize an apparatus in any of the examples of the present application.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. The eNB (or other base station) and UE (or other mobile station) may also include a transceiver component, a counter component, a processing component, and/or a clock component or timer component. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present invention. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

As used here, artificial intelligence and machine learning refer to engineered, machine-based systems that, for a given set of objectives, generate outputs such as predictions, recommendations, or decisions that influence real or virtual environments, and that can operate with varying levels of autonomy. In this specification, a “model” denotes a parameterized function learned from data and used to transform inputs into outputs for a defined task, such as classification, detection, ranking, or regression. “Training data” denotes samples used to fit a model's parameters, while “validation” and “test” data are held out to assess generalization and to measure performance under conditions representative of expected use. “Features” denote measurable attributes derived from raw inputs. “Hyperparameters” control the learning process but are not learned during training. A “loss function” quantifies the discrepancy between model outputs and target values for optimization. “Inference” denotes the forward application of a trained model to new inputs. These definitions follow commonly accepted technical usage and NIST-aligned terminology for AI systems and trustworthy AI attributes.

A trained model's trustworthiness is characterized along multiple dimensions, including validity and reliability, safety, security and resilience, accountability and transparency, explainability and interpretability, privacy enhancement, and fairness with harmful bias managed. In particular, the model's accuracy measures closeness of outputs to true or accepted true values on representative test sets; robustness describes the ability to maintain performance across a variety of circumstances; and reliability concerns correct operation under expected conditions over time. This specification uses such measures to quantify model performance and to support the stated technical improvements.

In representative embodiments, data sources are collected and processed through a reproducible pipeline. Raw inputs are cleansed to remove corrupt or out-of-domain records; features are engineered or selected, and values are normalized or standardized as appropriate for the learning algorithm. The dataset is partitioned into training, validation, and test subsets using stratification or cross-validation when appropriate to preserve class balance and to avoid leakage. Documentation of data provenance, schema versions, feature definitions, and preprocessing steps enables traceability and facilitates reproducible training and evaluation. When sensitive data are involved, privacy-enhancing approaches, de-identification, or aggregation may be employed with explicit acknowledgment that certain techniques can trade off accuracy for privacy.

The present disclosure can be implemented with a variety of supervised and unsupervised model families, including linear and logistic models, decision trees and ensembles, support vector machines, and neural networks such as convolutional, recurrent, and transformer architectures. The learning process configures parameters to minimize a defined loss function subject to regularization; optimization may proceed via stochastic gradient descent or adaptive variants, with early stopping and weight decay used to reduce overfitting. Hyperparameters are selected with validation-set performance as an objective, and hyperparameter ranges are disclosed for representative implementations. The training procedure includes initialization, forward and backward passes, parameter updates, and convergence checks. The trained model is persisted with associated metadata describing the training configuration and data subsets used, enabling retraining and auditing.

Performance is quantified on held-out test datasets using task-appropriate metrics. For classification, these can include accuracy, precision, recall, F1, calibration error, and area under receiver operating characteristic curves, supplemented by confusion matrices and subgroup disaggregation. For regression, mean squared error, mean absolute error, and R-squared can be used. Robustness is evaluated by measuring performance under distributional shifts and stress conditions reflective of expected deployment contexts. Reliability incorporates longitudinal monitoring to detect drift, performance degradation, or anomalous behavior; model update triggers and rollback protocols are defined. Where applicable, the system's risk profile is assessed in view of trustworthiness attributes, and residual risk is documented commensurate with organizational tolerance.

During inference, the model executes deterministically or stochastically on input features to produce outputs, subject to latency, throughput, and resource constraints of the deployment environment. The inference path includes feature extraction consistent with training, model execution, and post-processing to generate actionable outputs. Implementations can exploit vectorized operations, quantization, and hardware acceleration. A governance layer enforces input validation, output reasonableness checks, and logging sufficient to enable traceability and error investigation. The system exposes interfaces for real-time or batch inference and supports safe rollback to prior model versions as needed.

The disclosed systems improve computer functionality and performance in at least the following ways relative to generic, conventional computer implementations: they reduce computation or memory footprint for a given predictive accuracy by employing specialized model architectures and training curricula; they increase throughput and reduce latency by optimizing the inference path and data movement; and they improve prediction quality under distributional shift through explicit robustness techniques and online monitoring with defined remediation triggers. These improvements are realized by the concrete structures and algorithmic steps disclosed herein, not by generic automation of a known process, and they are measurable via the stated metrics and test methodologies executed on representative deployment conditions.

For limitations that encompass classification functionality, the corresponding structure includes a processor configured by non-transitory instructions to execute the following algorithm: receive an input vector of features; normalize each feature using stored scaling parameters; compute a score via a learned linear transformation followed by a nonlinear activation; convert scores to probabilities using a softmax or logistic function; compare the probabilities to a decision criterion; and output the predicted class label together with the probability as a confidence measure. For limitations directed to feature extraction, the corresponding structure includes a processor executing a sequence of operations comprising tokenization or sampling, dimensionality reduction using a learned projection or convolutional filter bank, and aggregation to a fixed-dimension representation suitable for downstream inference. For ranking functions, the corresponding structure includes a processor executing pairwise or listwise loss-driven scoring functions with learned weights, followed by ordering according to computed scores. Each disclosed algorithm can be expressed equivalently in flow-chart or mathematical form and corresponds to the claimed function as linked herein.

In embodiments where the model's outputs influence human decisions, the system implements transparency and explainability measures appropriate to the role of the user. Documentation describes model purpose, training data provenance, limitations, and known failure modes. Post-hoc or inherently interpretable techniques provide information about how and why outputs were produced within the system's design context, enabling debugging, audit, and governance. Fairness and harmful bias are monitored with measures aligned to the task and context; where feasible, mitigations are applied during data curation, training, or post-processing. These practices are designed to support operation consistent with trustworthy AI characteristics while recognizing potential tradeoffs between interpretability, privacy, and accuracy.

The disclosed methods may be executed on one or more general-purpose or specialized processors, with memory storing code, models, parameters, and data. Network interfaces support data ingestion and service integration. Program instructions configure the processor to perform the algorithms described above so that the effectively corresponding structure is the special-purpose computer programmed to execute those algorithms; descriptions of “modules,” “mechanisms,” or “engines” refer to such programmed processors unless otherwise indicated by explicit hardware circuitry.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the invention is not to be limited to the details given herein, but may be modified within the scope and equivalents of the appended claims.

Those having skill in the art will appreciate that many changes may be made to the details of the above-described embodiments without departing from the underlying principles of the invention. The scope of the present invention should, therefore, be determined only by the following claims.

1. A modular electrochemical sensing system, comprising:
one or more interchangeable sensor modules each comprising a substrate carrying a plurality of electrochemical electrodes comprising a plurality of working electrodes and at least one reference electrode, wherein one or more of the plurality of working electrodes comprises chemically selective membrane material that generates respective electrical responses to respective target analytes when exposed to a fluid or porous-media sample;
an electronic reader comprising a module interface configured to removably connect with the one or more interchangeable sensor modules, the electronic reader comprising measurement circuitry configured to acquire signals from the plurality of working electrodes with respect to the at least one reference electrode, and the electronic reader comprising a communication interface configured to transmit data representing the acquired signals; and
a data processing subsystem operatively coupled to the electronic reader, the data processing subsystem comprising one or more processors and memory storing calibration instructions that, when executed by the one or more processors, transform the data representing the acquired signals into corrected outputs.

2. The system of claim 1, wherein the at least one reference electrode comprises a silver/silver-chloride reference couple in ionic communication with an electrolyte reservoir and covered by at least one ion-permeable polymeric membrane configured to regulate ion flux to maintain reference-potential stability and reduce drift.

3. The system of claim 1, wherein, for at least one of the target analytes, the plurality of working electrodes includes a redundant group of two or more substantially similar electrodes configured to generate respective electrical responses to the at least one of the target analytes.

4. The system of claim 3, wherein the electronic reader and the data processing subsystem are configured to continue providing the corrected outputs when fewer than all electrodes of the redundant group remain within predetermined performance thresholds by excluding or down-weighting signals from electrodes that exceed the thresholds.

5. The system of claim 1, wherein the data processing subsystem implements a trained machine-learning model configured to compensate for measurement drift and cross-parameter interference to generate the corrected outputs in real-time.

6. The system of claim 1, wherein each interchangeable sensor module further comprises additional working electrodes configured to generate electrical responses indicative of pH and electrical conductivity.

7. The system of claim 1, wherein the chemically selective membrane material comprises one or more ion-selective membranes including ionophores configured to selectively respond to nitrate and potassium.

8. The system of claim 1, wherein the electronic reader comprises a wireless communication module configured to wirelessly transmit the data to the data processing subsystem.

9. The system of claim 1, wherein at least one of the plurality of working electrodes comprises an electrochemical transistor configured for potentiometric, voltammetric, or amperometric interrogation.

10. The system of claim 1, further comprising one or more of a temperature sensor, an electrical conductivity sensor, another reference electrode, and a physical property sensor.

11. A replaceable sensor module, comprising:
a substrate carrying conductive structures that define electrical interconnects and a reader interface region configured to releasably mate with a reader device;
a plurality of electrochemical electrodes disposed on the substrate and electrically coupled to the electrical interconnects, the plurality of electrochemical electrodes comprising:
(a) a plurality of working electrodes comprising a first redundant group of two or more substantially similar ion-selective electrodes, each including chemically selective membrane material configured to generate an electrical response to a first target analyte when exposed to a fluid or porous-media sample, and
(b) at least one reference electrode comprising a reference couple in ionic communication with an electrolyte reservoir and covered by at least one ion-permeable polymeric membrane configured to regulate ion exchange to maintain reference-potential stability and reduce drift during exposure to a sample of a fluid or porous-media; and
a protective encapsulation layer overlying at least a portion of the conductive structures and defining openings that expose active surfaces of the plurality of electrochemical electrodes while inhibiting fluid ingress to the conductive structures.

12. The sensor module of claim 11, further comprising at least one additional working electrode selected from an ion-selective electrode for a second target analyte different from the first target analyte of the first redundant group, a pH-sensitive electrode, and an electrical-conductivity sensing structure formed by a pair of spaced electrodes.

13. The sensor module of claim 11, wherein the at least one reference electrode comprises a silver/silver-chloride reference couple in ionic communication with the electrolyte reservoir.

14. The sensor module of claim 11, further comprising at least one counter electrode disposed on the substrate and electrically coupled to the electrical interconnects.

15. The sensor module of claim 11, wherein the plurality of electrochemical electrodes further comprises a second redundant group of two or more substantially similar ion-selective electrodes, each including chemically selective membrane material configured to generate an electrical response to a second target analyte different from the first target analyte.

16. The sensor module of claim 11, wherein the reader interface region comprises a plurality of conductive pads arranged to engage corresponding contacts of the reader device.

17. A method for monitoring chemical analytes and physical parameters in fluid or porous-media, comprising:
contacting an interchangeable sensor module with a sample of the fluid or porous-media, the interchangeable sensor module comprising a plurality of electrochemical electrodes, the plurality of electrochemical electrodes comprising at least one reference electrode and a plurality of working electrodes functionalized with chemically selective membrane material configured to generate respective electrical responses to one or more target analytes of the sample;
interrogating, by an electronic reader, the plurality of electrochemical electrodes with respect to the at least one reference electrode using one or more electrochemical measurement modalities to acquire raw sensor data;
transmitting, by the electronic reader, the sensor data to a data processing subsystem;
transforming, by the data processing subsystem, the sensor data into corrected analyte values by applying a trained calibration model configured to compensate for one or more of sensor drift, environmental variability, and cross-ion interference; and
outputting the corrected analyte values for real-time monitoring.

18. The method of claim 17, wherein the one or more electrochemical measurement modalities are selected from potentiometry, voltammetry, impedimetry, and amperometry to acquire the sensor data.

19. The method of claim 17, further comprising exchanging the interchangeable sensor module for another interchangeable sensor module in accordance with a replacement schedule.

20. The method of claim 17, wherein transforming the sensor data into the corrected analyte values comprises performing ensemble averaging with outlier rejection across signals from working electrodes that report a same target analyte and continuing to compute the corrected analyte values when fewer than all electrodes of a redundant set remain within predetermined performance thresholds by excluding or down-weighting signals from electrodes that exceed the predetermined performance thresholds.

21. The method of claim 17, further comprising outputting the corrected analyte values through an application programming interface for machine-to-machine integration with an external control system and providing event notifications upon detection of out-of-range conditions.
